(19) United States
(12) Patent Application Publication
(10) Pub. No.: US 2009/0152954 A1
(43) Pub. Date: Jun. 18, 2009

(54) RF energy harvesting circuit

(76) Inventors: Triet Tu Le, Portland, OR (US); Terri S. Flez, Corvallis, OR (US); Kartikeya Mayaram, Corvallis, OR (US)

Correspondence Address: LUMEN PATENT FIRM, 2345 YALE STREET, SECOND FLOOR, PALO ALTO, CA, 94306, US

(21) Appl. No.: 12/218,761

(22) Filed: Jul. 17, 2008

Related U.S. Application Data
(60) Provisional application No. 60/961,009, filed on Jul. 17, 2007.
(60) Provisional application No. 60/993,260, filed on Sep. 10, 2007.

(51) Int. Cl. H02M 3/18; H02J 17/00

(52) U.S. Cl. 307/110; 307/149

(57) ABSTRACT

A voltage doubler rectifier RF power harvesting system is provided having at least one power harvesting module with a voltage doubler rectifier that includes a DC voltage input and output, signal input, first and second floating gate transistors that are connected in series between the DC voltage input and output, and a gate control of the floating gate is connected to a drain of the transistor. The voltage double rectifier includes a first capacitor disposed between the input signal and the drain of the first floating gate transistor, and a second capacitor disposed between a ground and the drain of the second floating gate transistor. The system includes an input antenna and a transmitter with a transmitter antenna, where a full-wave peak-to-peak voltage of an incoming RF signal is rectified. The system also includes a powered device connected to the DC voltage output to utilize the rectified signal.

### CROSS-REFERENCE TO RELATED APPLICATIONS

This application is cross-referenced to and claims the benefit from U.S. Provisional Patent Application 60/961,009 filed Jul. 17, 2007, and from U.S. Provisional Patent Application 60/993,260 filed Sep. 10, 2007, which are hereby incorporated by reference.

### STATEMENT REGARDING FEDERALLY SPONSORED RESEARCH OR DEVELOPMENT

The present invention was supported in part by grant number DBI-0529223 from the National Science Foundation (NSF). The U.S. Government has certain rights in the invention.

### FIELD OF THE INVENTION

The invention relates generally to energy harvesting. More particularly, the invention relates to the conversion of radio frequency electromagnetic power to electrical power.

### BACKGROUND

Power extraction is an increasingly important technology, especially in applications relating to harvesting power from propagating radio frequency (RF) signals. RF powered devices are often used in applications where battery replacement is impossible, such as structural monitoring where the RF powered devices are embedded into a structure. Other applications for RF powered devices are in telemetry systems to remotely measure and report data back to a central processing unit, and in passive radio frequency identification (RFID) or passive RF tags to replace the bar code as a new form of data collection, where passive RFID tags are typically used in the range of 1-3 meters. Further, many modem biomedical implants are passively powered with radio waves to prolong the lifetime of the implanted device, and to reduce the chances of infection and chemical instability from the use of batteries. These biomedical implants generally operate within close proximity of the base station (typically 1-50 cm) and require robust designed since there is little tolerance for error in implanted devices. RF powered devices are also used in ultra-low power sensor networks in remote areas to eliminate the need for batteries in the sensor system to keep the sensor network free of maintenance, however they may have a backup battery in case the power provided by the RF radiation is insufficient. The applications for these sensor networks normally require an operating distance of 3 to 100 meters. Other applications for RF powered devices include access control, equipment monitoring and even personal identification.

RF powered devices require a power conversion circuit that can extract enough DC power from the incident electromagnetic waves for the passive device to operate. Far field RF powered devices are known to generally operate from distances of less than 10 meters from the RF source due to the high power loss from RF wave propagation at UHF frequencies. Other known devices achieve sufficient power but provide low output voltage with higher load current making them inadequate for use in passively powered wireless sensor networks.

For far-field RF energy harvesting applications, the RF energy is extracted from the air at a very low power density, since the propagation energy drops off rapidly as distance from the source is increased. More specifically, in free space, the electric field and power density drop off at the rate of 1/d², where d is the distance from the radiating source. Here, the available power to a receiver in a far-field RF harvesting device decreases by 6 dB for every doubling of distance from the transmitter. Further, with multi-path fading, the power density drops off at a much faster rate than 1/d². It is therefore critical that the power conversion circuit operate at very low receive power to achieve longer operating distance.

One of the major challenges to achieving this goal is the relatively high voltage requirement of rectifying circuits currently employed. When the available RF power to the receiver is under 100 μW, the available voltage for rectification in the RF to DC conversion system falls below 0.3V, which is much too low to overcome the threshold voltage (Vₜₕ) of conventional rectifier circuits. Currently, far-field RF energy harvesting circuits known in the art require a start-up circuit.

Accordingly, there is a need to develop an efficient rectifier circuit as well as improved system level design for RF to DC power conversion. What is needed is a highly efficient passive power conversion circuit for long distance passive sensing in distributed sensor networks. Further, new rectification circuits for far-field RF energy harvesting devices are needed to improve on the minimum power-threshold requirements for the system to operate. To overcome this power-threshold, significantly more efficient circuit and system level design is required over what is known in the art, especially in reducing or eliminating the need for a start-up circuit. Solutions must be found to circumvent or diminish the “dead-zone” in voltage rectification and otherwise reduce the effective threshold voltage in standard CMOS rectifier designs.

### SUMMARY OF THE INVENTION

To address the current needs for a robust and efficient energy harvesting system, a voltage doubler rectifier RF power harvesting system is provided. The system includes at least one power harvesting module, where the power harvesting module has a voltage doubler rectifier structure circuit that includes a DC voltage input, a DC voltage output, a signal input, a first floating gate transistor and a second floating gate transistor, where the floating gate transistors are connected in series between the DC voltage input and the DC voltage output, and a gate control of the floating gate is connected to a drain of the transistor. The voltage double rectifier structure further includes a first capacitor disposed between the input signal and the drain of the first floating gate transistor, and a second capacitor disposed between a ground and the drain of the second floating gate transistor. The voltage double rectifier RF power harvesting system further includes a harvester antenna, where the harvester antenna is disposed to provide a signal to the signal input. Additionally included are a transmitter and a transmitter antenna, where the transmitter provides the signal for output from the transmitter antenna, and a full-wave peak-to-peak voltage of an incoming RF signal from the antenna to the signal input is rectified. The system also includes a powered device, connected to the DC voltage output to utilize the rectified signal.

In one embodiment of the current invention, the at least one power harvester further includes at least one charge storage device, where the charge storage device can include capacitors, rechargeable batteries, or non-rechargeable batteries, and the charge storage device is disposed between the voltage doubler rectifier structure and the powered device.

According to another embodiment of the invention, the at least one power harvester further includes a voltage limiting/regulation device, where the voltage limiting/regulating device is disposed between the voltage doubler rectifier structure and the powered device. Here, the embodiment can further include feedback loops where the feedback loops are feedback connections that can include the powered device to the voltage doubler rectifier structure, the powered device to the voltage limiting/regulation device, or the voltage/regulation device to the voltage doubler rectifier structure. This embodiment can also include at least one charge storage device disposed between the powered device and the voltage doubler rectifier.

According to another embodiment of the invention, the at least one power harvester further includes a power management device, where the power management device is disposed between the voltage doubler rectifier structure and the powered device. Here, the embodiment can further include feedback loops, where the feedback loops are feedback connections that can include the powered device to the voltage doubler rectifier structure, the powered device to the voltage limiting/regulation device, the powered device to the power management device, the power management device to the voltage limiting/regulation device, the power management device to the voltage doubler rectifier structure, or the voltage/regulation device to the voltage doubler rectifier structure. This embodiment can also include at least one charge storage device disposed between the powered device and the voltage doubler rectifier.

According to another embodiment, the at least one power harvester further can include an impedance matching device disposed between the harvester antenna and the voltage doubler rectifier. In this embodiment the impedance matching is an adjustable impedance matching, where the adjustment is programmable. Further, the adjustable impedance matching can be programmable.

In a further embodiment of the current invention, the at least one power harvester further includes passive components disposed between the signal input and the harvesting antenna, where a wider band match is provided along a cascade of the power harvesters.

In yet another embodiment, the floating gate transistor can be a PMOS-PMOScap, a PMOS-NMPScap, an NMOS-NMOScap, an NMOS-PMOScap, an NMOS-MiMcap, or a PMPS-MiMcap.

In a further embodiment, the harvesting antenna is a meanderline antenna, where the meanderline antenna includes an inner loop disposed between a pair of approximately matching outer loops, where the inner loop has a pair of antenna ports, and an input impedance of the meanderline antenna matches an in impedance of the voltage doubler rectifier. Here, the antenna outer loop can have a perimeter of 35 centimeters. Further, the antenna inner loop can have a perimeter to match the input impedance of the rectifier. Additionally, the antenna matching outer loops are disposed to divide the antenna into two identical parts as a virtual ground, where a fully differential signal is provided at the antenna ports.

In a further embodiment, the voltage doubler rectifier structure can be disposed in at least a two-stage rectifier cascade. According to one embodiment, the cascade is a 36-stage cascade. According to another embodiment the cascade is a 16 stage cascade.

### BRIEF DESCRIPTION OF THE FIGURES

The objectives and advantages of the present invention will be understood by reading the following detailed description in conjunction with the drawing, in which:

FIG. 1(a) shows a drawing of communication links between base station (hub) and passively powered sensors in a passively powered sensor network according to the present invention.

FIG. 1(b) shows a diagram of an RF-DC power conversion system in a passively powered sensor according to the present invention.

FIG. 2 shows a block diagram of a passive RF-DC conversion circuit showing the equivalent circuit representation for the antenna and rectifier according to the present invention.

FIG. 3 shows a graph of the effect of impedance mismatch in high Q resonators.

FIG. 4 shows a diagram of parasitic components that affect performance of the RF-DC power conversion circuit.

FIG. 5(a) shows a prior art conventional voltage doubler rectifier.

FIG. 5(b) shows a diagram of a PMOS floating-gate rectifier according to the present invention.

FIG. 6 shows a diagram of a PMOS implementation of a floating gate transistor according to the present invention.

FIG. 7 shows a transistor level schematic of PMOS floating-gate rectifier according to the present invention.

FIG. 8 shows a diagram of a voltage doubler rectifier with N-stages in cascade according to the present invention.

FIGS. 9(a)-(d) show the effect of a number of rectifier stages on (a) maximum voltage gain, (b) output DC voltage, and (c and d) input impedance of rectifier, according to the present invention.

FIGS. 10(a)-(b) show (a) output voltage curves as function of the number of rectifier stages and the transistor width. (b) contour plot of constant output voltage according to the present invention.

FIG. 11 shows an antenna for an RF-DC converter according to the present invention.

FIGS. 12(a)-(d) show (a) and (b) simulated and measured components of the antenna input impedance, and (c) and (d) measured input impedance of antenna and rectifier circuit according to the present invention.

FIGS. 13(a)-(b) show (a) measured return loss, and (b) voltage gain for 36-stage rectifier design according to the present invention.

FIGS. 14(a)-(b) show die images of (a) 16-stage rectifier circuit, and (b) 36-stage rectifier circuit fabricated in a 0.25 mm CMOS process according to the present invention.

FIGS. 15(a)-(d) show measured output DC voltage (a) as a function of the sinusoidal input, (b) as function of input power, (c) as function of distance, and (d) measured voltage efficiency according to the present invention.

FIG. 16 shows PCB to establish performance of the RF-DC power converter at the system level according to the present invention.

FIGS. 17(a)-(f) show measured DC output voltage (a) as function of distance and load for the 36-stage rectifier, and (b) as function of received power for the 36-stage rectifier. (c) Measured output power performance as function of distance and load for the 36-stage rectifier. (d) Measured output power as function of received power for the 36-stage rectifier. (e) Measured power conversion efficiency curves as function of distance and load for the 36-stage rectifier. (f) Measured power conversion efficiency curves as function of received power for the 36-stage rectifier according to the present invention.

FIG. 18 shows a graph of the measured energy extracted per hour as function of distance for the 36-stage rectifier according to the present invention.

FIG. 19 shows a shows a block diagram of one embodiment of the energy harvesting system according to the present invention.

FIG. 20 shows a diagram of one embodiment of a power harvester with voltage limiting/regulation, charge storage devices and power management according to the present invention.

FIGS. 21(a)-(i) show diagrams of various feedback loops with a power harvester with voltage limiting/regulation, charge storage devices and power management according to the present invention.

FIG. 22 shows a block diagram of one embodiment of power harvester according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The present invention is directed to systems, circuitry and techniques for obtaining, recovering, acquiring and/or harvesting electrical energy from an environment having/including radio frequency (RF) signals (for example, signals in the is a frequency or rate of oscillation within the range of about 3 Hz and about 30 GHz). The RF signals may be periodic or non-periodic. The environment is generally described as being local to the system (for example, within a radius of 40 meters, and more preferably, within a radius of 3 meters). In one embodiment, the system consists of RF power harvester circuitry to obtain, recover, acquire and/or harvest (hereinafter collectively “harvest” or the like (for example, “harvests”, “harvested”, “harvesting”)) the RF electromagnetic waves from the environment. The RF waves may come in the form of a power transmitter or ambience RF wave. In operation, an RF signal is received by the harvester circuitry, which converts the RF signal into a voltage to be used by devices (for example, a substantially DC voltage). In one embodiment, the power harvester circuitry employs floating-gate transistors to provide improved power conversion efficiency of the system.

An RF-DC power conversion system is provided, which efficiently converts far-field RF energy to DC voltages at very low received power and voltages. Passive rectifier circuits are provided in a 0.25 μm CMOS technology using floating gate transistors as rectifying diodes. A 36-stage rectifier disclosed, according to one embodiment, can rectify input voltages as low as 50 mV with a voltage gain of 6.4 and operate with received power as low as 5.5 μW (−22.6 dBm). Implemented for far field, the circuit operates at a distance of 44 meters from a 4 W EIRP source. The high voltage range achievable at low load current, makes it practical for use in passively powered sensor networks.

The current invention provides a highly sensitive and efficient rectifier circuit and system level design for RF to DC power conversion. Fully passive rectifier circuits are provided in a 0.25 μm CMOS technology disposed to operate at very low received power. A receive antenna is provided in a 4-layer FR4 board to maximize power transfer in the system.

The harvested electrical energy can then be used to power one or more electrical devices. After RF signals are converted to DC signals, the invention can power an electrical device directly or it can incorporate other components, such as charge storage devices (e.g. batteries and capacitors), voltage limiters/regulators, power management devices, or any combination thereof. In another embodiment, the system can also incorporate feedbacks between any two or more of the components including the electrical device to be powered, the RF to DC converter, the voltage regulator, and the power management device.

When RF powered devices harvest their power from RF wave radiation, a radiating source or base station is required to transmit a high intensity RF signal wirelessly through the air. The RF signals can be within the range of about 3 Hz and about 30 GHz and may be periodic or non-periodic. The environment is generally described as being local to the system within a radius range of 3 to 40 meters.

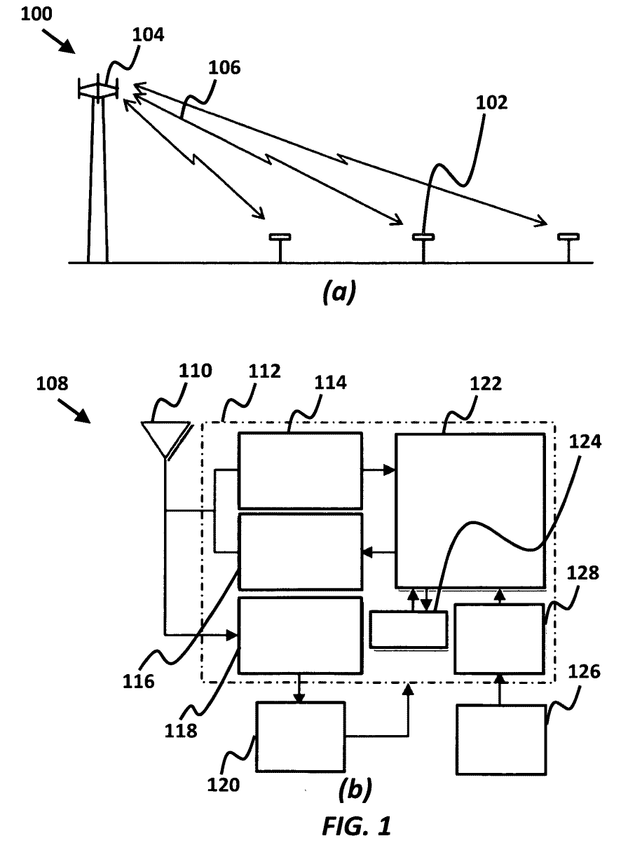

Referring now to the figures, FIG. 1(a) shows one embodiment of how the system operates as a network 100 where multiple energy harvesting systems 102 receive their energy from the same power source (shown as a hub or base station) 104, however the RF waves 106 may also come in the form of ambient RF waves 106. FIG. 1(b) shows a diagram of an RF-DC power conversion system 108 in a passively powered sensor 102 according to one embodiment of the current invention, where the RF-DC power conversion system 108 includes an antenna 110, connected to an integrated circuit 112. Here, the integrated circuit 112 includes a receiver 114 and a transmitter 116, which are connected to the antenna 110 and, optionally, to each other. The integrated circuit further includes an RF-DC converter 118 connected to the antenna 110. According to this embodiment, the integrated circuit 112 has a holding capacitor 120 connected to the RF-DC converter 116 for receiving and holding the converted power, and providing power back to the integrated circuit 112. Further shown is a baseband processing block 122 connected to receive a signal from the receiver 114 and connected to provide a signal to the transmitter 116. Further, the baseband processing block 122 is connected to receive and provide signals with an electrically erasable programmable read-only memory (EEPROM) 124. Further shown in this embodiment is an ancillary sensor 126 connected to the integrated circuit 112 through an analog to digital converter interface 128, which may provide an additional signal for further power conversion or other sensing capabilities.

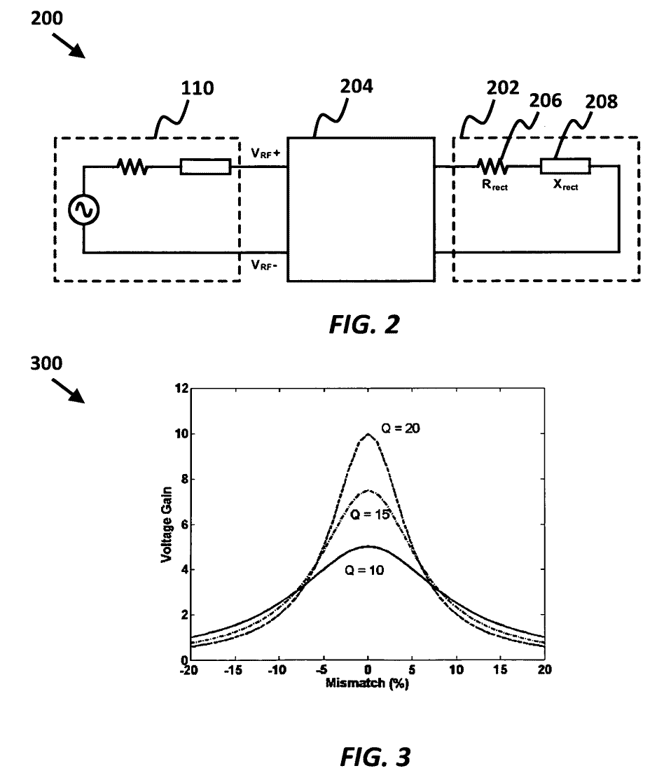

FIG. 2 shows a diagram of a passive RF-DC conversion circuit 200 showing the equivalent circuit representation for the antenna 110, rectifier 202 and impedance matching 204. The RF to DC power conversion system of the current invention operates in UHF frequencies in the industrial, scientific and medical bands (ISM band) of 902-928 MHz. In this frequency range, RF power is transmitted more efficiently for longer distances and experiences lower propagational losses than higher frequency bands (i.e., 2.4 GHz). The system is optimized to operate at distances above 10 meters with the capacity to store charge for long periods of time. Given that the power density drops off at the rate of 1/d² in free space, the propagational RF signal loss through the air at 915 MHz can be calculated to be 51.6 dB with the Friis equation for freespace loss. The maximum transmit power allowed by the FCC in the 902-928 MHz band is 36 dBm, equivalent isotropically radiated power (EIRP) (30 dBm maximum transmit power with 6 dB antenna gain), thus the received power for distances greater than 10 meters is below 27 μW, this translates to less than 75 mV in a 50Ω matched system. The power conversion circuit must be highly sensitive for long-range operation, thus the threshold voltage of the system must be greatly reduced to improve power conversion efficiency at distances greater than 10 meters. It is also essential to come up with design techniques at the system level that can increase the voltage available for rectification to further increase the power conversion efficiency.

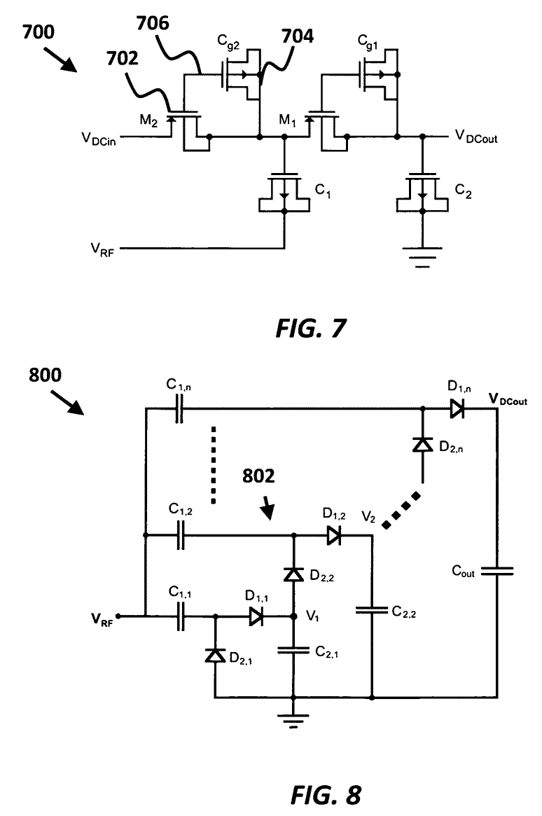

An RF-DC power conversion system is provided to passively amplify the voltage available for rectification by forming a high-Q resonator. The system maximizes the voltage coming into the RF-DC power conversion system 108 so that it can provide a stable DC output voltage at ultra-low receive power. The block diagram 200 of the system 108, shown in FIG. 2, consists of an antenna 110 to pick up the power radiated by the RF waves 106, an impedance matching network 204 to ensure maximum power transfer in the system 108, and a rectifier circuit 202 to convert the RF signal 106 to a DC voltage. The passive amplification of voltage is done by matching the impedances between the receive antenna 110 and the rectifier circuit 202. Due to the high-Q nature of the voltage rectification circuit 202 (see circuit schematic in FIG. 5b) the impedance matching creates a high-quality factor (Q factor) resonator between the receive antenna 110 and the rectifier circuit 202.

A key aspect to improve the efficiency of the RF-DC power conversion at the system level, according to the current invention, is to maximize the input voltage to the rectifier 202. This is done by forming a resonator (see circuit schematic in FIG. 5b) with high-Q factor between the impedances of the receive antenna 110 and the rectifier circuit 202. By doing this, it passively amplifies the incoming RF signal 106. To ensure the maximum possible power is transferred to the rectifier circuit 202, the impedance of the receive antenna 110 is matched to the input impedance of the rectifier circuit 202. Due to the fact that systems with high-Q resonate with greater amplitude at the resonant frequency than systems with low-Q, the high-Q resonator acts as a passive voltage-amplifier to increase the peak voltage coming into the input of the rectifier without dissipating additional power. The passive voltage gain from the high-Q resonator is directly proportional to its Q. With an increase in the amplitude of the voltage coming to the input of the rectifier 202, the output voltage of the rectifier 202 also increases and, therefore, increases the overall power conversion efficiency of the system 108. One drawback of the high-Q resonator is it can reduce the operating bandwidth of the RF-DC power conversion system 108 since

$$Q = ω \cdot ( \frac{Energy Stored}{Average Power Dissipated} ) or Q = \frac{{f}_{c}}{Δ f} \qquad ( 1 )$$

where ω is the resonant frequency in radians/second, f_{c} is the center frequency of operation, and Δf is the bandwidth of the system. For the far-field RF-DC power conversion system 108 operating in the band 902-928 MHz, the maximum Q that can be attained without sacrificing bandwidth is 35. This limitation on the system Q does not cause much concern since on-chip components rarely have Q of more than 10, and the parasitic resistance from these components damp out the resonator to prevent the Q of the system from limiting the bandwidth. In the case of a series connected matched LC resonator, the reactive components are complex conjugates of each other and the resistive components are matched. The Q of the resonator is therefore

$$Q = \frac{1}{2} \frac{ω L}{R} = \frac{{X}_{L}}{2 R} or Q = \frac{1}{2} \frac{1}{ω RC} = \frac{{X}_{C}}{2 R} \qquad ( 2 )$$

where X_{L} and X_{C} are the reactive components, and R is the resistive component of the LC resonator. The Q of the resonator is half the Q of the rectifier and antenna since the resistance in the series connected matched resonator is doubled. To achieve a high system Q, it is therefore desirable to increase the reactive components of the rectifier 202 and antenna 110 while reducing resistive components.

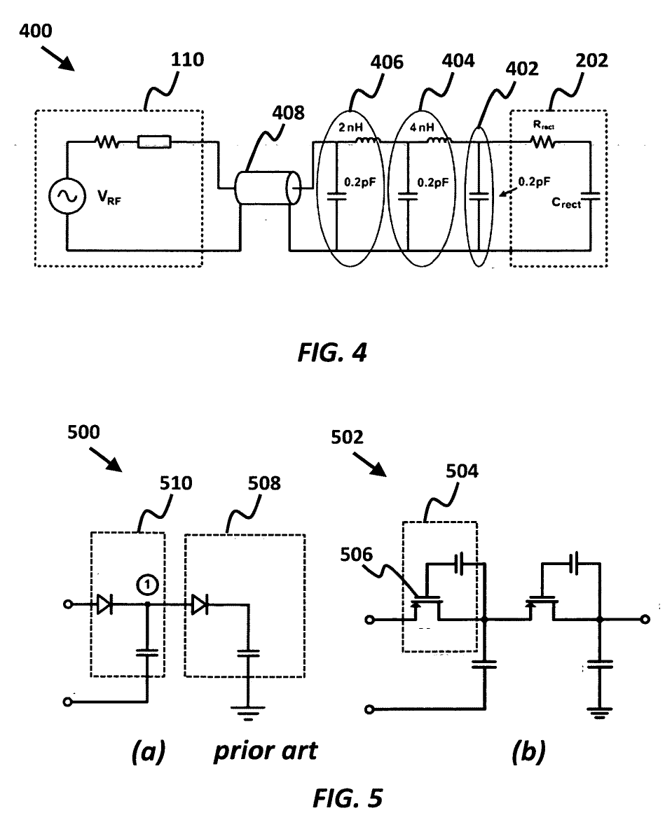

A matching network 204 between the receive antenna 110 and rectifier 202 is necessary to fine tune the impedance match between the antenna 110 and the rectifier 202 to further reduce transmission loss and increase the voltage gain. Coarse impedance matching is done through circuit and antenna design but fine impedance matching must also be done on the PCB for more accurate matching. FIG. 3 shows a graph of the simulated effect 300 of impedance mismatch for a typical high Q resonator. The maximum voltage gain that can be attained is equal to the Q of the resonator, or half that of the rectifier Q. With impedance mismatch greater than 7%, the passive voltage gain from the resonator is reduced to below 3 regardless of the resonator Q. With impedance mismatch greater than 15%, the high-Q matching network provides no voltage gain and even yields a voltage attenuation that becomes greater with increasing Q. The impedance mismatch between the antenna and rectifier must be minimized to obtain a high voltage gain.

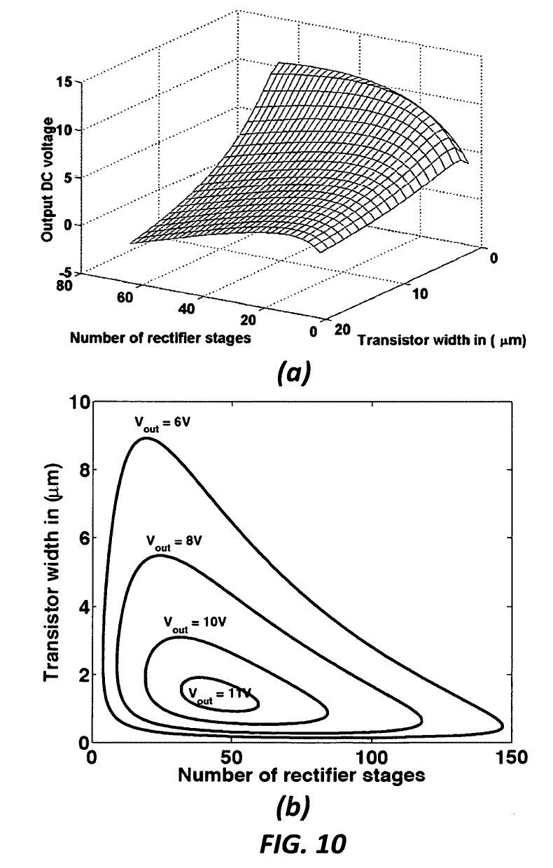

From the top-level diagram of FIG. 2, the rectifier circuit is modeled by impedance with a real part R_{rect} 206 and a reactive part X_{rect} 208. From the system point of view, the rectifier circuit 202 must be designed to reduce threshold voltage loss (Vₜₕ) as much as possible to improve the efficiency of the RF-DC power conversion system 108. The rectifier circuit (see FIG. 5(b)) must also be provided so that the output voltage can be scaled by cascading multiple rectifier stages in series (see FIG. 8). Improving the Q of the rectifier input impedance is essential to increasing the power conversion efficiency of the overall system 108. The rectifier input impedance Q should also be kept as high as possible and parasitic components in the rectifier must be kept as low as possible to maintain a high overall system Q and thus power conversion efficiency.

The number of cascaded rectifier stages (see FIG. 8) in the RF-DC conversion system 108 also has a significant effect on the rectifier input impedance. In a conventional voltage rectification circuit design (see FIG. 5(a)) in CMOS technology, the rectifier impedance as seen from the input is capacitive and resistive due to the gate capacitance and the channel resistance (r_{ds}) of the MOS transistor. In general, cascading multiple rectifier stages in series causes capacitive components to increase linearly with the number of stages, while providing parallel paths causes the resistive component to decrease. With a large number of stages, the resistive component from the rectifier is so low that it is dominated by other sources of parasitic resistance (i.e. drain and source connection resistors) and hence, the Q of the system is reduced due to the linearly increased parasitic capacitance.

Conversely, if there are too few rectifier stages in cascade, the output voltage of the rectifier may not be high enough to operate the sensor node. As the number of rectifier stages increases, the DC output voltage increases until the number of rectifier stages reaches an optimal point. Adding more stages beyond the optimal point reduces the system Q and causes a reduction in the DC output voltage. Thus, it is critical for the number of rectifier stages to be selected through thorough circuit simulation so that the output DC voltage is maximized while maintaining a high system Q to achieve maximum power conversion efficiency.

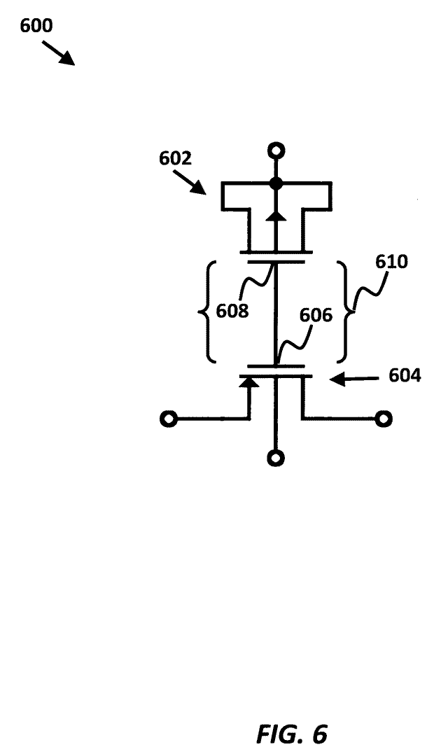

The current invention provides a reduction of the unwanted parasitic components that affect system performance. Since the system is to be designed with a high-Q resonator, any additional parasitic components between the antenna and rectifier will greatly diminish the performance of the power conversion system. It is therefore critical to specify an accurate parasitic model for simulating the effect of all parasitic components that affect power conversion efficiency. In the design of the RF-DC power conversion system, the traces connected to inputs of the rectifier are most sensitive to parasitics since a high-Q resonance is required at these inputs. For example, FIG. 4 shows an equivalent circuit model 400 for the parasitic components that affect the power conversion efficiency of the rectifier circuit.

These parasitic components cannot be avoided altogether, but the value of each parasitic component can be reduced through careful layout and package selection. The bond pad 402 can be designed to be minimum size and only consisting of the top two metal layers to reduce bond pad capacitance to the substrate. The package for the integrated circuit is selected so that pin-parasitics are minimized and critical input pins 404 are placed in locations where the length of bond wires 406 is minimized. PCB traces 408 are made as short as possible and they are impedance controlled to reduce the parasitic capacitance and inductance.

The antenna 110 structure is critical in the RF-DC power conversion system since it must extract the power radiated by the RF waves 106. The antenna 110 performs best when it is impedance matched to the rectifier circuit 202 at the operating frequency to reduce transmission loss from PCB traces. Also, the antenna 110 must be small in area and must have a bandwidth large enough to cover the frequency band from 902-928 MHz.

FIG. 5(a) shows the conventional voltage doubling rectification circuit 500, and FIG. 5(b) shows a floating-gate rectification circuit 502 according to the current invention. For the floating-gate rectification circuit 502, floating-gate devices 504 are used to create a gate-source bias to reduce the threshold voltage loss of the MOS transistor 506.

The voltage doubler rectifier structure is provided for the RF-DC power conversion system because it rectifies the full-wave peak-to-peak voltage of the incoming RF signal and it can be arranged in cascade to increase the output voltage. The voltage conventional doubler rectifier 500 in FIG. 5(a) consists of a peak rectifier 508 formed by D₁ and C₂ and a voltage clamp 510 formed by D₂ and C₁. The voltage clamp 510 and the peak rectifier 508 are arranged in cascade configuration to provide a passive level shift in voltage before rectification.

In the negative phase of the input, current flows through diode D₂ while D₁ is cutoff. The voltage across diode D₂ stays constant around its threshold voltage and the voltage at node (1) is charged to −Vₜₕ₂. At the negative peak, the voltage across capacitor C₁ is Vₐₘₚ−Vₜₕ₂, where Vₐₘₚ is the amplitude of the input signal. In the positive phase of the input, current flows through diode D₁ while D₂ is in cutoff. The voltage across capacitor C₁ remains the same as the previous phase because it has no way to discharge. At the positive peak, the voltage across D₂ is 2Vₐₘₚ−Vₜₕ₂. Since D₁ is conducting current to charge C₂, the voltage at the output is a threshold voltage below that across D₂, i.e., the voltage at the output Vₒᵤₜ is 2Vₐₘₚ−Vₜₕ₂−Vₜₕ₁.

For the floating-gate rectifier circuit 502 of the current invention, the diodes D₁ and D₂ of the conventional rectifier circuit 500 are replaced by diode-tied floating gate transistors 504. The floating gate devices 504 are provided to passively reduce the threshold voltage of the rectifier circuit 502. In a floating gate device 504, when charge is injected into the floating gate of the transistor 506, it remains in the gate oxide because of the high impedance provided by the oxide layer. The gate oxide is a very good insulator, which keeps the charge from leaking off in the floating gate 504.

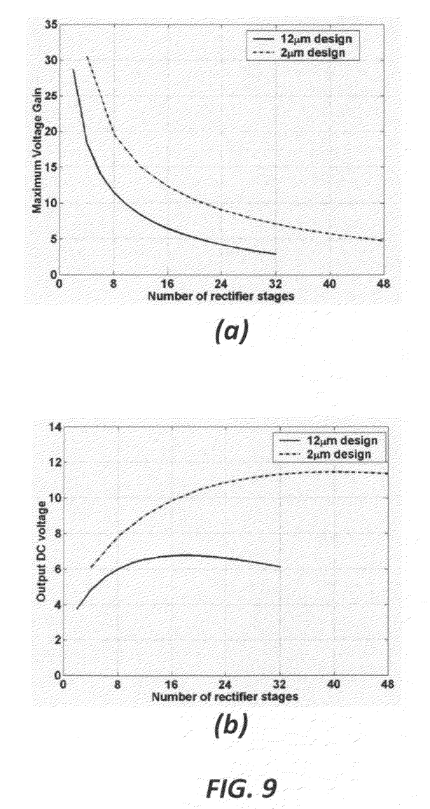

To provide a floating gate device 600 in a standard CMOS process, a MOS capacitor 602 is placed in series with the gate 606 of the diode-tied transistor 604 as shown in FIG. 6. The gate of the diode-tied transistor 606 and the MOS capacitor gate 608 are connected together to form a high impedance node to trap charges in the floating gate 610. The charge in the floating gate 610 is therefore fixed which results in a fixed voltage bias across the MOS capacitor 602. The charges that are trapped inside the floating gate device 600 act as a gate-source bias to passively reduce the effective threshold voltage of the transistor 604.

The charge on the floating gate 610 can be injected via Fowler-Norheim (F-N) tunneling when the rectifier is not operating, or it can be charged by injecting a relatively large sinusoidal signal to the input of the rectifier at any time. The Fowler-Norheim tunneling technique charges the floating gate 610 to the desired voltage much faster, but the amount of charge is harder to control and also, additional circuitry is needed to inject or remove charge from the floating gate 610. Referring again to FIG. 5(b), the rectifier circuit 502 of the current invention is provided to have charge injected to the floating gate 504 with a relatively large sinusoidal input with amplitude larger than the threshold voltage of the transistor 506 used for rectification. With the large sinusoidal voltage injection, charge is injected to the floating gate 504 via the parasitic capacitance between the gate-source and gate-drain junction of the transistor 506. With the floating-gate device 504, the threshold voltages of the diode-tied transistors M₁ and M₂ are reduced by creating a gate-source bias. The gates of transistors M₁ and M₂ in FIG. 5(b) are high impedance nodes so any charge trapped in the floating gates 504 can be retained for a long time. Retaining charge in floating-gate devices 504 is critical to the useful lifetime for the power conversion circuit in the current invention. With the 70-angstrom oxide thickness in the 0.25 μm CMOS process, the device retains charge in the floating gate 504 in excess of 10 years for normal operation at room temperature. However, the performance of the rectifier circuit 502 may reduce slightly as charge is leaked from the floating gate 504. During fabrication, the residual charge trapped in the floating gate 504 may also affect the threshold voltage of the rectifier circuit 502, hence the floating gate 504 must be programmed to account for these residual charges.

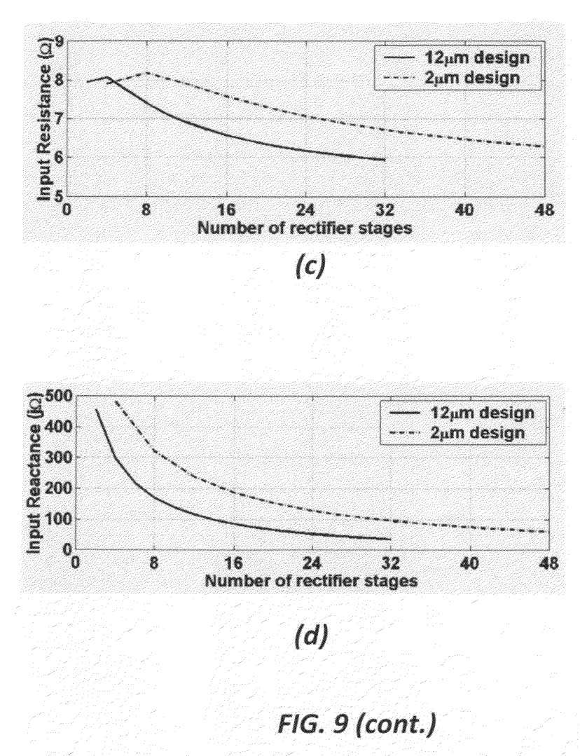

The transistor level schematic of the 36-stage floating-gate rectifier 700 is shown in FIG. 7. V_{RF} represents the input signal extracted from the RF wave 106 (not shown), V_{DCin} is the input DC voltage coming from the previous rectifier stage (not shown) and V_{DCout} is the output DC voltage of the rectifier 700. The 36-stage embodiment 700 uses diode-tied PMOS transistors 702 as rectifying devices and a MOS capacitor (MOSCAP) 704 is used to create the gate-source bias for each individual diode-tied transistor 702 in the rectifier 700. The MOSCAPs 704 (C_{g1} and C_{g2}) generally operate in the depletion region and their capacitance is a function of the applied voltage. To create the gate-source bias, a large sinusoidal signal is applied at the input of the rectifier 700 and charge is injected over time through the parasitic capacitance of the diode-tied transistors 702. When the gate-source bias reaches a potential close to Vₜₕ, the capacitance reaches a flat point and remains constant. The amount of charge stored in the floating gate 708 reaches equilibrium and the MOSCAP 704 operates in the inversion region, the source-gate bias voltage is, therefore, approximately the threshold voltage of the diode-tied transistors 702 (M₁ and M₂).

The individual stages of the floating-gate voltage doubler rectifier circuit can be arranged in cascade to increase the output voltage of the rectifier. FIG. 8 shows N stages of a voltage doubler rectifier in cascade 800. When the rectifier stages 802 are cascaded, each rectifier stage 802 acts as a passive voltage level shifter in addition to the voltage shift in voltage clamp and peak rectification. The number of rectifier stages 602 used in the design is important since too few rectifier stages yields insufficient output voltage and too many rectifier stages damps out the effect of the high-Q resonator.

One of the important tradeoffs in the voltage doubler rectifier is the size of the transistor versus parasitic capacitance. The smaller the transistor size, the less parasitic capacitance it has, however, rectification efficiency is lowered by the smaller transistor size since smaller transistor can deliver less current to the load. The transistor sizes can be reduced to a few times the minimum width to reduce parasitic capacitance as seen from the input of the rectifier, however, the reduction in channel width may cause a decrease in the performance of the rectifier due to the increase in the channel resistance of the diode-tied transistors. As an example, two different sample designs are provided to compare the tradeoffs between a reduction in the parasitics and the rectifier performance.

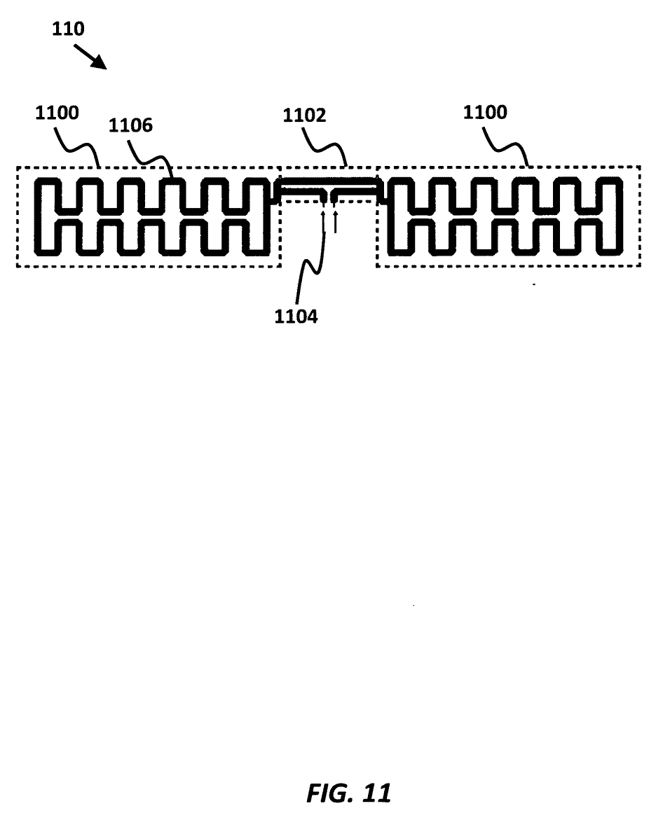

The first sample design uses a relatively large device size of 12 mm/0.24 μm (NMOS) and the second uses 2 μm/0.24 μm PMOS devices. FIG. 9(a) shows the maximum voltage gain that can be achieved in the rectifier with different numbers of floating-gate rectifier stages arranged in cascade. As the number of rectifier stages increase, the resonator Q between the antenna and rectifier impedance is reduced. In fact, the resonator Q is inversely proportional to the number of rectifier stages.

The output voltage of the rectifier for both designs with an input voltage with 300 mV amplitude is shown in FIG. 9(b). The output voltage initially increases as more rectifier stages are added until an optimal point then it reduces as the resonator Q is decreased. The impact of the number of rectifier stages on the input impedance is shown in FIGS. 9(c) and 9(d). As the number of rectifier stages increase, the capacitive component in the rectifier input impedance increases thus reducing the reactive component of the rectifier input impedance. The reactive component of the rectifier input impedance is found to be inversely proportional to the number of rectifier stages. With the decrease in the reactive component, the maximum voltage gain that can be achieved at the input is also decreased at the same rate since the resistive component in the input impedance stays fairly constant. In this example, the optimized number of cascaded rectifier stages for the 12 μm (NMOS) and 2 μm (PMOS) designs is 16 and 36 stages, respectively. The simulated input impedance for the two samples is 6.6-j85Ω and 6.6-j84Ω, almost identical to each other.

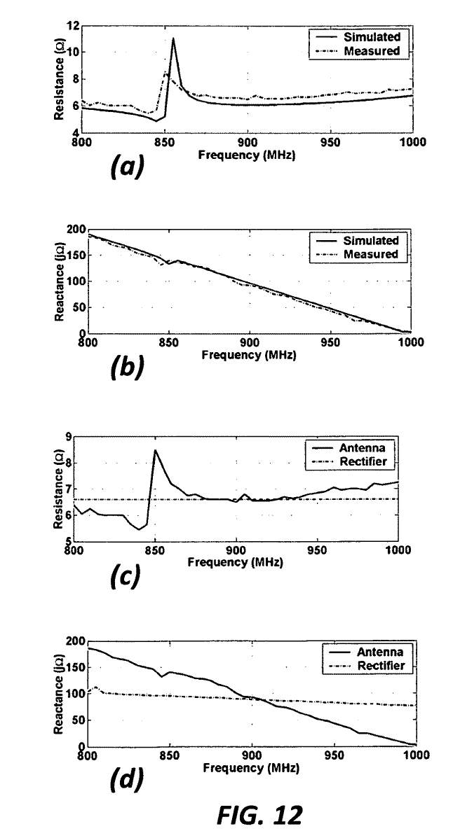

To establish the tradeoff between the transistor size used for rectification versus the number of rectifier stages, a model is extracted by curve fitting of the output voltage data for the two different designs. FIG. 10(a) shows a 3-dimensional surface plot for the rectifier output voltage as a function of the number of rectifier stages and the transistor width. It can be observed that a width of 2 μm is the best design choice for the highest output voltage when the number of rectifier stages is below 40. Any increase in device size from 2 μm results in a reduction in the output voltage. Reducing the device size below 2 μm could lead to a slight improvement in the output voltage. However, the number of rectifier stages required is significantly increased which results in a larger die size. FIG. 10(b) shows the constant output voltage contour plot as function of the transistor width and the number of rectifier stages. The 36-stage design with a 2 μm device size is very close to the highest voltage contour, thus, this design is optimal for the output voltage.

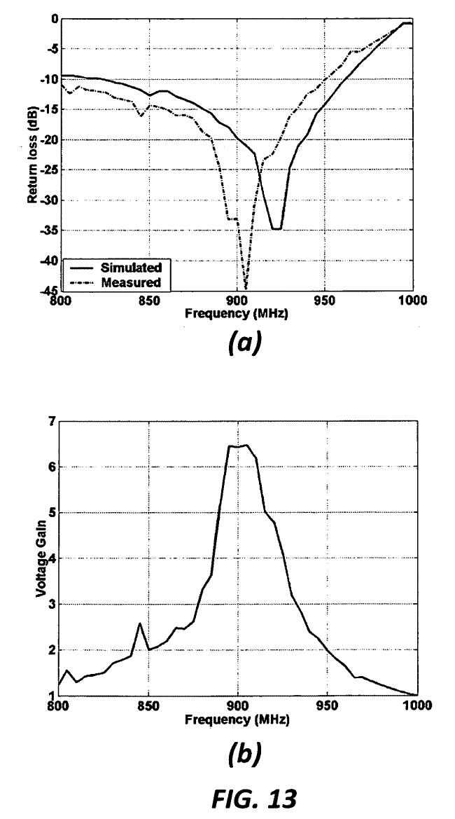

The antenna 110 for the RF-DC conversion circuit 108 is designed with meander lines on a printed circuit board to reduce the area of the antenna 110 and to provide the desired antenna input impedance to the impedance matching network. FIG. 11 shows one embodiment of the antenna with two outer loops 1100 on each side connected to an inner loop 1102 in the center. The antenna ports 1104 are in the middle and connect to the antenna 110 through the inner loop 1102 to transform the impedance as seen from the outer loops 1100 of the antenna 110. To achieve resonance at the desired frequency, the antenna 110 is provided to match with the input impedance of the floating-gate rectifier circuit 502, 700, 800). The outer loop 1100 of the antenna 110 is designed to tune the antenna 110 to the correct operating frequency and the perimeter of the loop 1100 is 35 centimeters, roughly equal to one wavelength at 916 MHz, according to this embodiment. The perimeter of the inner loop 1102 varies depending on the value of the input impedance of the rectifier (502, 700, 800). The line of symmetry between the two sides of the antenna 110 splits the antenna 110 into two identical parts and this acts as a virtual ground to create the fully differential signal at the antenna ports 1104. The dimension of the drawn area of the antenna is 15 cm×2 cm (6×0.8 inches). The antenna 110 is tuned for maximum received power at 916 MHz and the antenna is designed on the top layer of a 4-layer FR4 board with carefully controlled impedance to ensure the impedance of PCB traces does not vary from the intended values. According to one embodiment, the traces 1106 in the antenna 110 are exposed so that they can be tapped to fine tune the operating frequency. The impedance matching network 204 (see FIG. 2) can be placed anywhere along the antenna 110 to fine-tune the matching between the antenna 110 and the rectifier circuit (502, 700, 800). The antenna 110 has a bandwidth of about 40 MHz to maintain a high antenna Q. Due to the fact that the antenna 110 must be impedance matched to the rectifier (502, 700, 800), the loop configuration provides little antenna gain in the antenna 110 throughout the frequency bandwidth it operates.

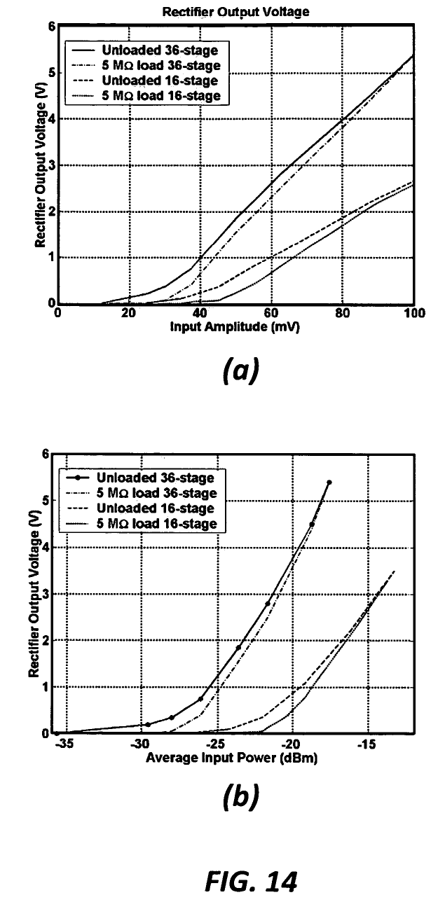

FIG. 12(a) shows the simulated and FIG. 12(b) shows measured input impedance of the antenna 110 around the operating frequency band. The measured resistive component shows less than 1Ω variation from the simulated value and the reactive component also correlates well with the simulated results. The simulated impedance shown in FIG. 12(c) and the measured input impedance shown in FIG. 12(d) corresponds to the components of the receive antenna 110 for the 36-stage rectifier configuration (see FIGS. 7 and 8). From the measurement data, the measured resistive components of the antenna 110 and rectifier (502, 700, 800) match well throughout the intended bandwidth for both embodiments. The reactive component of the 36-stage design matches at 910 MHz.

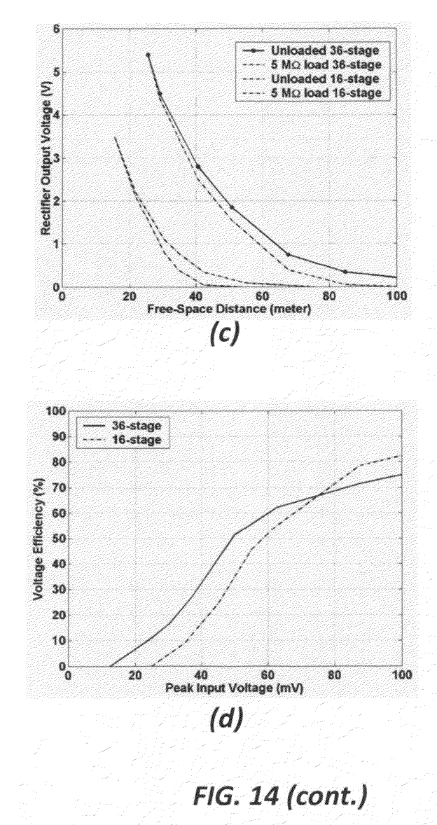

FIG. 13(a) shows the plot of the return loss (S₁₁) and FIG. 13(b) shows the voltage gain for the 36-stage configuration. The antenna 110 matches so that less than 1% of the transmitted signal is reflected back to the antenna (i.e. S₁₁ below −20 dB) in the frequency band of operation 902-928 MHz. The configuration achieves voltage gain above 5 in a 30 MHz bandwidth, however the peak voltage gain is shifted down by approximately 10 MHz from the intended 915 MHz center frequency.

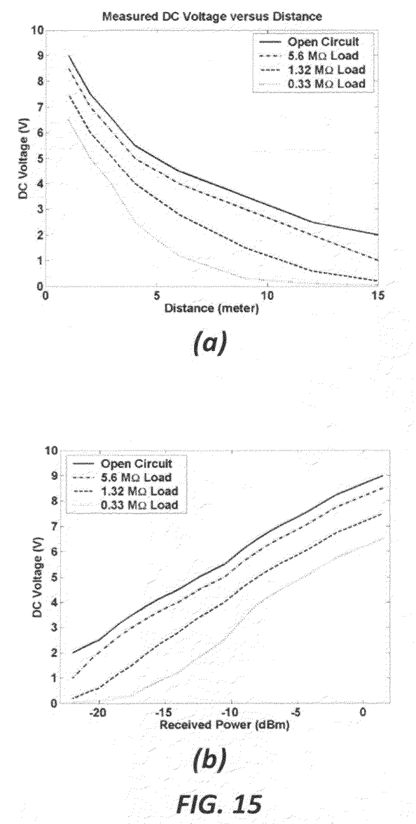

As an example of the efficacy of the current invention, rectifier devices with 16 NMOS stages and 36 PMOS stages were fabricated in a 0.25 μm 5 metal single-poly CMOS process as shown in FIGS. 14(a) and (b), respectively. The active die areas are 350 μm×600 μm and 400 μm×1000 μm, respectively. The majority of the active area is consumed by the MOSCAPs for floating gate devices and the holding capacitors. The 16-stage and 36-stage rectifier layouts are arranged in two rows of 8 stages each, and six rows of 6 stages each, respectively. Both dies have a pair of 1-stage rectifiers included so that the functionality of the NMOS and PMOS diode-tied floating-gate devices can be individually characterized. Each rectifier is packaged in a 0.5 mm pin pitch QFN-32 package to reduce bond wire parasitics and trace lengths on the PCB.

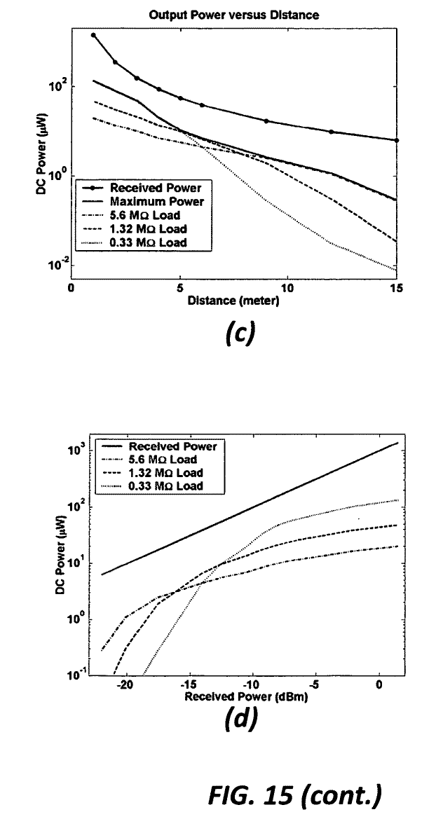

In order to test the rectifier circuit, a small-amplitude 1 MHz sinusoidal signal is applied directly to the input. The low frequency signal minimizes parasitic effects introduced by the board as well as voltage losses in the PCB traces. FIG. 15(a) shows the measured output DC voltage unloaded and with a 5 MW load for both rectifier designs as a function of the input sinusoidal amplitude, FIG. 15(b). From a straight-line extrapolation of the output voltage curves, the threshold voltage for the 16-stage rectifier is 33 mV compared to 30 mV for the 36-stage rectifier. Since the difference in threshold voltages is very small between the two rectifier designs, the improvement in the output voltage of the 36-stage rectifier is primarily due to the higher number of cascaded rectifier stages used in the design.

The performance of the rectifier circuit can be specified by the sensitivity of the rectifier or the minimum input power required for voltage rectification. The average input power can be expressed as:

$$P = \frac{{QV}_{rms}^{2}}{R} = \frac{{QV}_{amp}^{2}}{2 R} \qquad ( 3 )$$

where Q is the passive voltage gain from the antenna to the input of the rectifier, VMS is the input rms voltage to the rectifier, Vₐₘₚ is the rectifier input amplitude and R is the input impedance of the rectifier circuit. The voltage gain of the 16-stage and 36-stage rectifiers, measured from the return loss of the matching between the rectifier and antenna is 4.8 and 6.4, respectively. Assuming a rectifier input impedance of 7Ω, the equivalent input power is derived and shown in FIG. 15(b). In the case of the 16-stage rectifier, 2V is achieved for 80 mV input, which is equivalent to a power 20.95 μW (−16.8 dBm). Using the Friis formula for free-space wave propagation, this corresponds to an operating distance 23 meters (FIG. 15(c)) assuming a 4 W radiating source. This is the maximum theoretical distance that can be achieved with this design while keeping radiated power and antenna gain under the FCC emission limit. For the 36-stage rectifier circuit, the rectifier performs better with low voltages due to the increased number of voltage doubler rectifier stages and the higher passive voltage gain. The 36-stage rectifier circuit achieves 2V for an input voltage amplitude as low as 50 mV. Using (3), these values are equivalent to 4.7 μW of power (−23.3 dBm) at 2.0 V output. In free-space, this corresponds to 49 meters in distance.

Defining the voltage efficiency as the percentage of the theoretical voltage achieved, the theoretical output for the voltage doubler architecture is the number of cascaded rectifier stages times the peak-to-peak voltage into the rectifier. In the case of the 16-stage rectifier, the theoretical output voltage is 16 times the input peak-to-peak voltage. For input voltages above 100 mV, the rectifier efficiency is over 80% as shown in FIG. 15(d) and, hence, it is more efficient at higher input voltages. The voltage efficiency for the 36-stage design is higher as compared to the 16-stage rectifier design for low voltages.

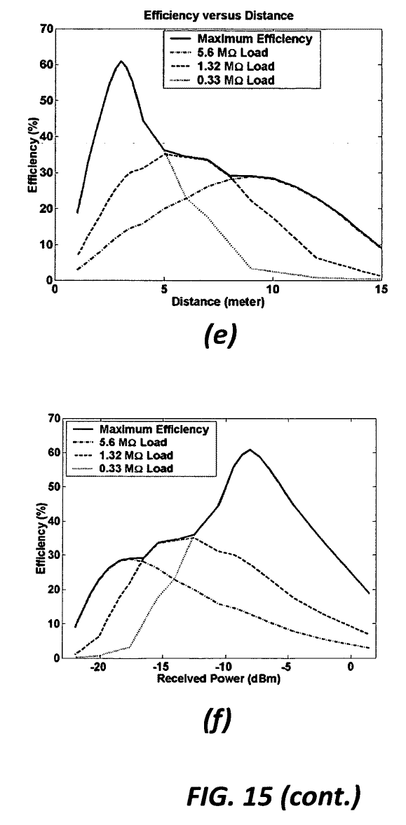

To test the overall performance of the RF-DC rectifier in actual applications, a custom printed circuit board was fabricated that includes the antenna with exposed metal traces for impedance and frequency tuning as shown in FIG. 16. The chip is directly soldered to the board and physically abuts to the antenna to minimize any stray inductance. The output DC voltage is observed via the SMA connector with an oscilloscope or a digital multimeter (DMM).

The performance of the RF-DC power conversion system can be measured wirelessly with propagating electromagnetic wave radiation. The output of an HP/Agilent 8665A signal generator is amplified by a Mini Circuits LZY-2 power amplifier to generate signals with 6 W of power in the frequency range of 902-928 MHz. The signal at the output of the power amplifier is then fed to an antenna through several series connected SMA cables. The losses in the cable combined with the return loss between the power amplifier and the transmit antenna are measured to be around 1.7 dB. Thus, the maximum radiated power is about 36 dBm (4 Watts).

Only the 36-stage rectifier design is wirelessly measured since it has superior performance in terms of received power sensitivity. Before measuring the overall performance, it is necessary to tune the frequency of the resonator circuit. The resonant frequency can be tuned to the 902-928 MHz range by placing a shorted stub tuning on the bare metal trace at the end of the antenna on the PCB. The tuning of the resonant frequency does affect the output voltage of the RF-DC conversion circuit, since the shorted stub tuning slightly modifies the physical shape of the antenna. The decrease in the output voltage is greater when the original resonant frequency is further from the desired (i.e., longer length stub tuning) band and the decrease is smaller for a resonant frequency closer to the desired band. Although the frequency tuning does affect the output voltage, this change in output voltage is much smaller compared to the change in output voltage caused by impedance mismatch. For the 36-stage rectifier design, the resonant frequency is originally 860 MHz so the size of the loop is reduced only slightly to increase the resonant frequency to 906 MHz. For the wireless measurement of the RF-DC power conversion circuit, the center frequency is set at 906 MHz for the 36-stage rectifier design.

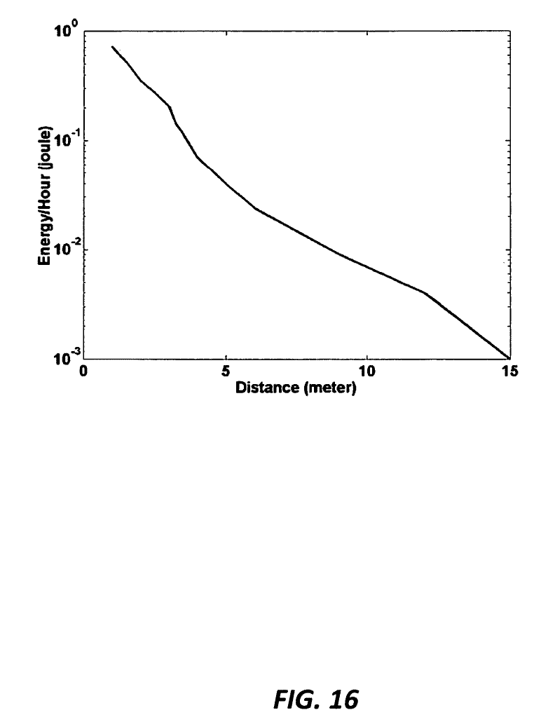

FIGS. 17(a) and (b) show the measured output voltage of the 36-stage rectifier as a function of distance and input power for various resistive loads. The 36-stage conversion circuit is capable of outputting DC signal levels of 2V at distances up to 15 meters with a 36 dBm radiating source when it is not loaded as shown in FIG. 17(a). The measured output DC voltage decreases exponentially as distance increases and also decreases as the load resistance is decreased. With a 0.33MΩ load, the conversion circuit operates within 7 meters from the radiating source while providing 1 volt DC. From observation, the operating distance of the rectifier reduces quickly as the load current is increased while at closer distances, the dependence on load current is much less. FIG. 17(b) shows the output voltage curves of the 36-stage design as function of received power calculated from the Friis equation for free-space propagation loss. The slope of the output voltage curves are relatively constant over the full range since the output voltage is inversely proportional to the log of the operating distance. The 36-stage design operates well when the received power is higher than −22 dBm.

FIG. 17(c) shows the measured output power as a function of distance. The top curve represents the theoretical received power in free-space as calculated by the Friis formula for free-space propagation loss given a 36 dBm radiating source. With a 0.33MΩ resistive load, the current requirement at the load is higher so more current is drawn from the output of the rectifier to drive the load hence the curve shows a steeper slope. The slope of the roll off is directly proportional to the load current at the output of the rectifier. With a 1.32 MΩ load, 1 μW at 10 meters is possible and up to 12.3 meters with the 5.6 MΩ load. FIG. 17(d) shows the output power as function of received power. From this plot, the point where the power curve starts to roll off from the straight (open circuit) line can be seen more clearly. For the 36-stage rectifier design, the output power starts to roll off at about −8 dBm for the 0.33 MΩ load, −13 dBm for the 1.32 MΩ load, and −18 dBm for the 5.6 MΩ load.

The measured power conversion efficiency versus distance curves are shown in FIGS. 17(e) and (f). The power conversion efficiency curve for each individual load is shown as well as the maximum efficiency that can be achieved at a particular distance. For a perfectly matched resonator network, the power available for rectification is half of the received power in the antenna since only half of the power is dissipated in the rectifier. The power conversion efficiency of the RF-DC power conversion system is defined as the ratio between the DC output power and available power for rectification (half of the received power) from the antenna. The maximum efficiency measured is 60% with the 0.33 Mb load. For lower load currents, the output power is higher at longer distances so the power conversion efficiency is also sufficient at longer distances from the RF source. The configuration is most efficient at 3 meters and the power conversion efficiency curves rolls off as the inverse of distance from the RF source. The peak efficiency with the 5.6 MΩ and 1.32 MΩ load is 29% at about 9 meters and 35% at 5 meters, respectively.

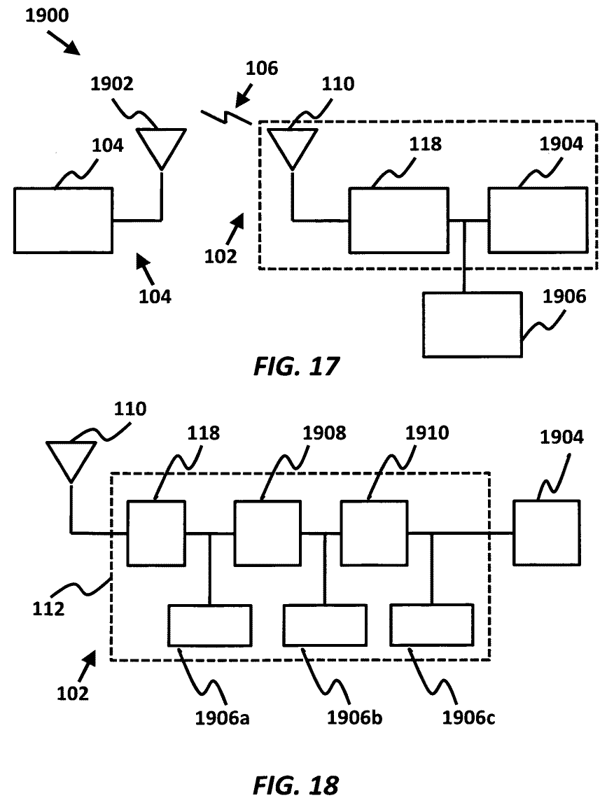

FIG. 18 shows the maximum energy that can be extracted from the RF signal in one hour at various distances from the radiating source. From the logarithmic plot of extracted energy against distance, the extracted energy curve is approximately a straight line. The maximum extractable energy in an hour is 0.8 J at 1 meter, 40 mJ at 5 meters, 7 mJ at 10 meters and about 1 mJ at 15 meters from the source. With one-hour charge time, the RF-DC power conversion circuit acquires and replenishes enough energy to operate a circuit that dissipates 1 mW for one second or 100 mW for 10 ms at distances up to 15 meter. For an increase of every meter in distance, the amount of energy that can be extracted from the RF signal is reduced by a factor of 2.6. This establishes the trade off between power dissipation and operating distance of the integrated circuit powered by the RF-DC power conversion circuit.

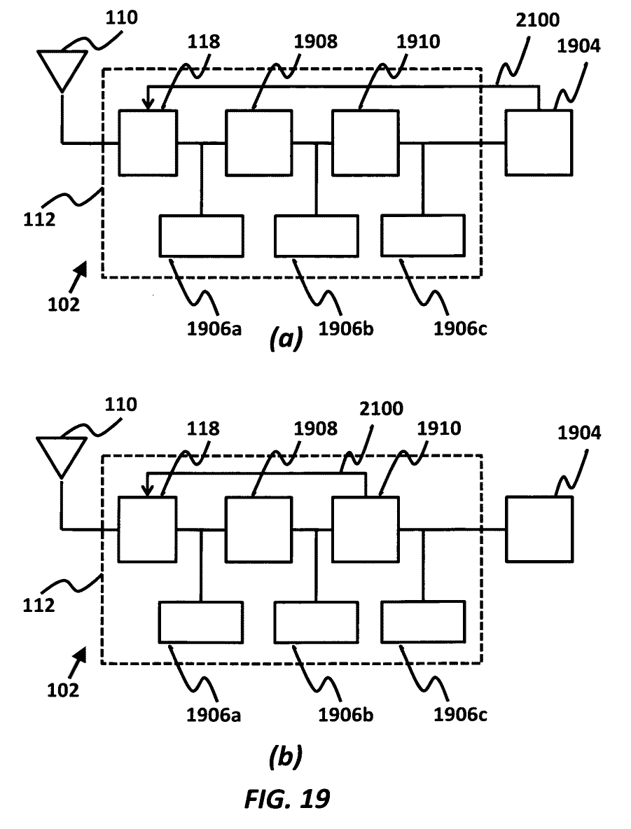

According to one aspect of the present invention, acquiring and/or harvesting electrical energy is done from an environment having RF frequency, or rate of oscillation, within the range of about 3 Hz and about 30 GHz. The RF signals may be periodic or non-periodic. FIG. 19 shows a block diagram of one embodiment of the energy harvesting system 1900, where the diagram shows how the RF waves 106 may come from a power transmitter 104 having a transmitter antenna 1902 however it is within the scope of the invention that the RF waves may be ambient RF waves, and be received by the energy harvester system 102. In operation, an RF signal 106 is received by the harvester circuitry 112 (see FIG. 2), which converts the RF signal 106 into a voltage to be used by devices 1904, for example, a substantially DC voltage. FIG. 19 is a diagram of an RF power harvesting system 102 that harvests RF signal 104 from ambient RF energy via one or more RF signal sources 104. The RF signal source 104 provides one or more RF signals 106, which may be continuous or non-continuous, and/or periodic or non-periodic, and/or wideband/multi-band or narrowband, where the power transmitter 104 can be powered by a wall outlet, a battery or other power sources. The harvesting antenna 110 collects the RF signal(s) 106 and the power harvester 102 converts the RF signal(s) 106 to a DC supply. The DC voltage may be used by various devices 1902, or stored on charge storage devices 1906, where the charge storage device may be external or internal to the system 102. The charge storage device 1906 stores the charge output by the power harvester 102 and, as needed, supplies the charge to the device 1904 for example, when its power dissipation exceed the power harvested by the power harvester 102. The charge storage 1906 device may also extend the operational usage time of the device by providing extra charge.

According to one embodiment of the invention, the power harvester 102 can communicate back to the transmitter 104 via radio link or via backscattering of the incident RF wave 106. The charge storage device may be considered external to the power harvester.

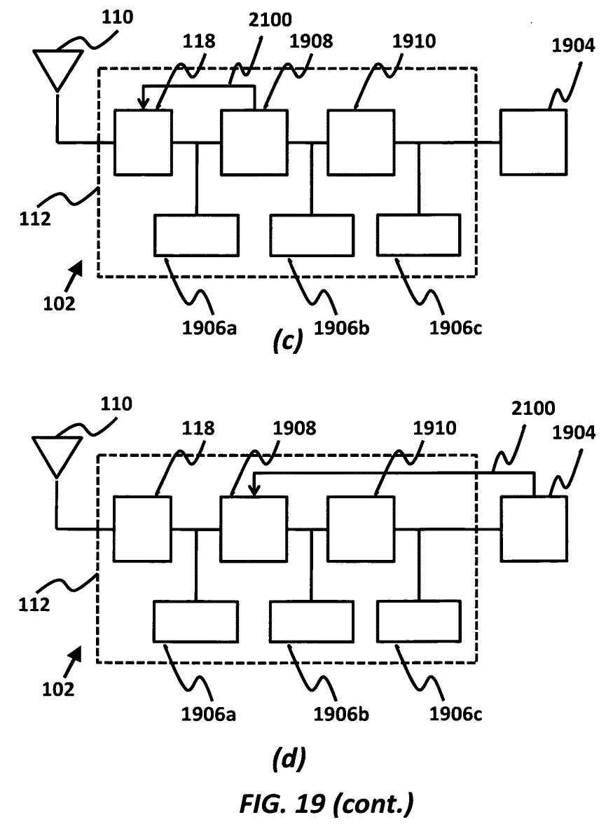

FIG. 20 is a diagram of an exemplary embodiment of a power harvester 102 with voltage limiting/regulation 1908, charge storage devices 1906 and power management 1910. The antenna 110 collects the RF signal 106 (not shown), the RF-DC rectifies 118 the RF signal 106 to a DC voltage that is stored on a charge storage device 1906a, the voltage limiter/regulator 1908 regulates the DC voltage from the charge storage device 1906a and its output charges a different charge storage device 1906b. Power management 1910, in this embodiment, controls the conduction path between the output of voltage regulator 1908 and the device 1904. Power management 1910 supplies power to the device 1904 when it is needed or instructed. Charge storage 1906c holds the excess charge from the power harvester 102 when device is in operation and gives off charge when device is drawing more current than the power harvester circuit 112 can provide. Notably, the power management 1910 may include a switch or circuitry, which controls, monitors and/or analyzes:
(i) the power harvesting operation of the power harvester and/or components thereof, for example, the power conversion circuitry;
(ii) the operating characteristics of the power harvester and/or components thereof;
(iii) the characteristics of the output power of the power harvester, for example current; voltage and temporal characteristics thereof;
(iv) the storage operation of one or more of the charge storage devices and/or charge supplied thereto (via, for example, the power harvester); and/or
(v) the characteristics of the output power of one or more of the charge storage devices, for example, current, voltage and temporal characteristics thereof.

The voltage limiting/regulation 1908 limits the voltage that can be charged to circuits and charge storage devices 1906 to prevent it from breaking down. The voltage regulation suppresses the voltage supply voltage variation to a small range, preferably under 100 mV of variation, over wide range of temperature, supply voltage and process variations.

The power management circuitry 1910 controls the charge transfer from the power harvester 102 to the device for safe operation. The power management 1910 may turn on the conduction path for charge transfer when power at the device 1904 is needed and turns off the conduction path when power is no longer needed. The power management 1910 may connect the power harvester 102 to the external device 1904 continuously, at a regular interval, or only once, depending on the operational power requirement of the device 1904.

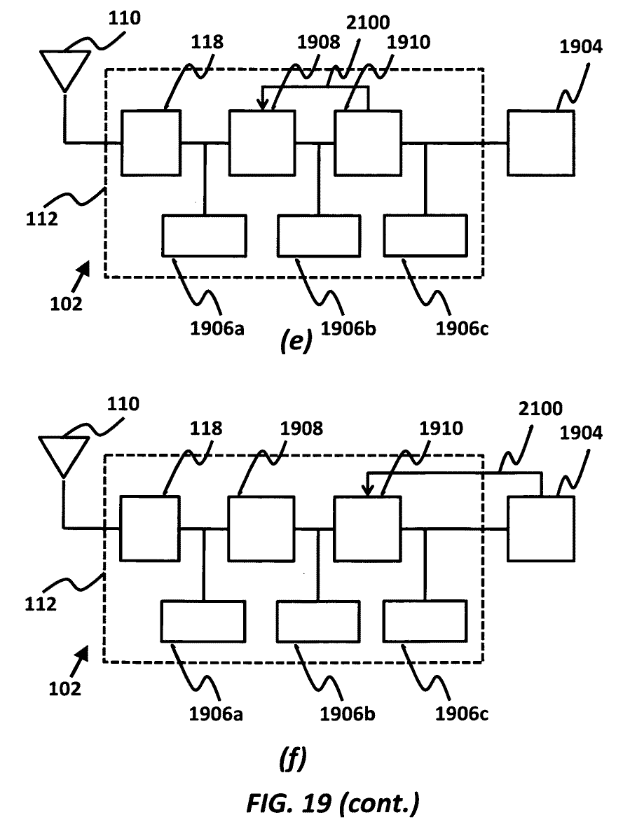

FIGS. 21(a)-(f) are diagrams of exemplary embodiments of a power harvester 102 with voltage limiting/regulation 1908, charge storage devices 1906 and power management 1910. In the embodiment shown in FIG. 21(a), a feedback 2100 between the device 1904 and the RF-DC power conversion 118 gives the device 1904 the control of the power harvester 102. The feedback loop 2100 can be used to partially or fully enabling and disabling the RF-DC power conversion 118. It can be used for tuning the RF-DC power conversion 118 for desirable performance and it can also be used to select between different circuit structures in the RF-DC power conversion 118. Feedback 2100 is preferred when the RF-DC power conversion 118 requires tuning for enhanced and/or optimized matching, or when communication to the transmitter is required. The device 1904 can trigger the impedance matching network in the RF-DC 118 from matched to total mismatch. For example, this exemplary embodiment of the power harvester 102 may enable a communication link to the transmitter via backscattering of the incident RF signal. On a system where the antenna is shared, the feedback can disconnect and isolate the RFDC block from the antenna.

In the embodiment shown in FIG. 21(b), the feedback 2100 between the power management 1910 and the RF-DC power conversion 118 allows the power management 1910 control of power harvester 102. The feed back loop 2100 can be used to partially or fully enabling and disabling the RF-DC power conversion 118. It can be used for tuning the RF-DC power conversion 118 for desirable performance and it can also be used to select between different circuit structures in the RF-DC power conversion 118. This feedback configuration may be preferred when the RF-DC power conversion 118 requires tuning for enhanced and/or optimized matching that must be controlled by the power management 1910. This configuration may be used to adjust the output voltage level of the RF-DC power conversion circuit 112, which in turn varies the voltage at regulator output to flexibly accommodate for the voltage requirement of the device 1904. On a system where the antenna is shared, the feedback may be employed to disconnect and isolate the RF-DC block from the antenna so it can be used for other purposes. The feedback loop 2100 can also be used for the purpose of triggering the charging the floating gate devices in certain rectifier circuits to enhance power conversion efficiency or minimize or prevent degradation in the performance of the power harvester.

FIG. 21(c) shows a diagram of a power harvester 102 with voltage limiting/regulation 1908, charge storage devices 1906 and power management 1910. The antenna 110 collects the RF signal 104 (not shown), the RF-DC 118 rectifies the RF signal to a DC voltage that is stored on a charge storage device 1906a, the voltage limiter/regulator 1908 regulates the DC voltage from the charge storage device 1906a and its output charges a different charge storage device 1906b. Power management 1910 controls the conduction path between the output of voltage regulator 1908 and the device 1904. Power management 1910 supplies power to the device 1904 when it is needed. Charge storage 1906c holds the excess charge from the power harvester 102 when device 1904 is in operation and gives off charge when device 1904 is drawing more current than the power harvester circuit 112 (not shown) can provide. The feedback 2100 between the voltage limiting/regulation 1908 and the RF-DC power conversion 118 allows the voltage limiting/regulation 1908 control of the power harvester 102. The feed back loop 2100 can be used to partially or fully enabling and disabling the RF-DC power conversion 118. It can be used for tuning the RF-DC power conversion 118 for desirable performance and it can also be used to select between different circuit structures in the RF-DC power conversion 118. This feedback configuration is preferred when the voltage limiter/regulation 1908 needs to directly adjust the output voltage level of the RF-DC power conversion 118 to prevent the voltage regulator circuit from getting over saturated in voltage or breaking down. The configuration can be use to aid in the tuning of the impedance matching networks in the RF-DC power conversion 118. It can also be used for the purpose of triggering the charging the floating gate devices in the rectifier circuits to enhance power conversion efficiency or prevent degradation in the performance of the power harvester.

FIG. 21(d) shows a diagram another embodiment of the power harvester 102 with voltage limiting/regulation 1908, charge storage devices 1906 and power management 1910. The antenna 110 collects the RF signal 106 (not shown), the RF-DC 118 rectifies the RF signal to a DC voltage that is stored on a charge storage device 1906a, the voltage limiter/regulator 1908 regulates the DC voltage from the charge storage device 1906a and its output charges a different charge storage device 1906b. Power management 1910 controls the conduction path between the output of voltage regulator 1908 and the device 1904. Power management 1910 supplies power to the device 1904 when it is needed. Charge storage 1906c holds the excess charge from the power harvester when device is in operation and gives off charge when device 1904 is drawing more current than the power harvester circuit 112 (not shown) can provide. The feedback 2100 between the device 1904 and the voltage limiting/regulation 1908 allows the device 1904 to control the regulated output voltage level of the power harvester 102. The feed back loop 2100 can be used to partially or fully enabling and disabling the voltage limiter/regulation 1908. It can be to select between different devices 1904 or reference voltages in the voltage limiter/regulation 1908 to robustly vary the voltage level as seen from the device 1908. This configuration is preferred when the device does not operate on a wide range power supply and requires the voltage regulation to be very accurate, preferably to within less than 50 mV of the desire operating voltage.

FIG. 21(e) shows a diagram of a power harvester with voltage limiting/regulation 1908, charge storage devices 1906 and power management 1910. The antenna 110 collects the RF signal 106 (not shown), the RF-DC 118 rectifies the RF signal to a DC voltage that is stored on a charge storage device 1906a, the voltage limiter/regulator 1908 regulates the DC voltage from the charge storage 1906a device and its output charges a different charge storage device 1906b. Power management 1910 controls the conduction path between the output of voltage regulator 1908 and the device 1904. Power management 1910 supplies power to the device 1904 when it is needed. Charge storage 1906c holds the excess charge from the power harvester 102 when device 1904 is in operation and gives off charge when device 1904 is drawing more current than the power harvester circuit 112 (not shown) can provide. The feedback 2100 between the power management 1910 and the voltage limiting/regulation 1908 allows power management circuits to control the regulated output voltage level of the power harvester 102. The feed back loop 2100 can be used to partially or fully enabling and disabling the voltage limiter/regulation 1908. It can be to select between different devices or reference voltages in the voltage limiter/regulation block to robustly vary the voltage level as seen from the device.

FIG. 21(f) shows a diagram of a power harvester with voltage limiting/regulation 1908, charge storage devices 1906 and power management 1910. The antenna 110 collects the RF signal 106 (not shown), the RF-DC rectifies the RF signal to a DC voltage that is stored on a charge storage device 1906a, the voltage limiter/regulator 1908 regulates the DC voltage from the charge storage device 1906a and its output charges a different charge storage device 1906b. Power management 1910 controls the conduction path between the output of voltage regulator and the device 1904. Power management 1910 supplies power to the device 1904 when it is needed. Charge storage 1906c holds the excess charge from the power harvester 102 when device 1904 is in operation and gives off charge when device 1904 is drawing more current than the power harvester circuit can provide. The feedback 2100 between the device 1904 and the power management 1910 allows device 1904 some control of the power management circuits. The feed back loop 2100 can be used to partially or fully enabling and disabling the power management 1910. This is desirable when the device 1904 operates frequently such that, power can be saved by turning off the power management circuit. The feedback 2100 also allows the control of how much charge is transferred from the power harvester 201 to the device 1904.

It should be obvious that the above embodiments can be provided without the power management block 1910, and without charge storage device 1906c, where the antenna 110 collects the RF signal 106 (not shown), the RF-DC rectifies the RF signal to a DC voltage that is stored on a charge storage device 1906a, the voltage limiter/regulator 1908 regulates the DC voltage from the charge storage 1906a device and its output charges a different charge storage device 1906b. Without the power management circuit, the device 1904 is directly powered by the power from the voltage limiting/regulation 1908 and the charge stored on charge storage 1906b.

It should be obvious that the feedback 2100 provided in FIGS. 21(a)-(f) can be applied in a similar manner without the power management block 1910, and without charge storage device 1906c. The antenna 110 collects the RF signal 106 (not shown), the RF-DC 118 rectifies the RF signal to a DC voltage that is stored on a charge storage device 1906a, the voltage limiter/regulator 1908 regulates the DC voltage from the charge storage device 1906a and its output charges a different charge storage device 1906b. Without the power management 1910, the device 1904 is directly powered by the power from the voltage limiting/regulation 1908 and the charge stored on charge storage 1906b. The feedback 2100 between the device 1904 and the RF-DC power conversion 118 gives the device 1904 the control the power harvester 102. The feed back loop 2100 can be used to partially or fully enabling and disabling the RF-DC power conversion 118. It can be used for tuning the RF-DC power conversion 118 for desirable performance and it can also be used to select between different circuit structures in the RF-DC power conversion 118. This feedback 2100 configuration is preferred when the RF-DC power conversion 118 requires tuning for optimized matching or communication to the transmitter 104 (not shown) is required. The device 1904 can trigger the impedance matching network 204 (not shown) in the RF-DC 118 from matched to total mismatch. This enables a communication link to the transmitter 104 via backscattering of the incident RF signal. On a system where the antenna is shared, the feedback can disconnect and isolate the RF-DC block from the antenna.

In another embodiment provided without the power management block 1910, and without charge storage device 1906c and having feedback 2100, the antenna 110 collects the RF signal 106 (not shown), the RF-DC 118 rectifies the RF signal 106 to a DC voltage, the voltage limiter/regulator 1908 regulates the DC voltage and its output is available to an external device 1904. The feedback 2100 between the voltage limiting/regulation 1908 and the RF-DC power conversion 118 allows the voltage limiting/regulation 1908 control of power harvester 102. The feedback loop 2100 can be used to partially or fully enabling and disabling the RF-DC power conversion 1910. It can be used for tuning the RF-DC power conversion 118 for desirable performance and it can also be used to select between different circuit structures in the RF-DC power conversion 118. This feedback 2100 configuration may be preferred when the voltage limiter/regulation 1908 needs to directly adjust the output voltage level of the RF-DC power conversion 118 to prevent the voltage regulator 1908 from getting over saturated in voltage or breaking down. The configuration can be use to aid in the tuning of the impedance matching networks in the RF-DC power conversion 118. It can also be used for the purpose of triggering the charging of the floating gate devices in the rectifier circuits to enhance power conversion efficiency or prevent degradation in the performance of the power harvester.

In another embodiment provided without the power management block 1910, and without charge storage device 1906c and having feedback 2100, the antenna 110 collects the RF signal 106 (not shown), the RF-DC 118 rectifies the RF signal 106 to a DC voltage, that is stored on a charge storage device 1906a, the voltage limiter/regulator 1908 regulates the DC voltage from the charge storage device 1906a and its output charges a different charge storage device 1906b. Without the power management circuit, the device is directly powered by the power from the voltage limiting/regulation 1908 and the charge stored on charge storage 1906b. The feedback between the voltage limiting/regulation 1908 and the RF-DC power conversion 118 allows the voltage limiting/regulation 1908 control of power harvester 102. The feed back loop 2100 can be used to partially or fully enabling and disabling the RF-DC power conversion 118. It can be used for tuning the RF-DC power conversion 118 for desirable performance and it can also be used to select between different circuit structures in the RF-DC power conversion 118. This feedback 2100 configuration is preferred when the voltage limiter/regulation 1908 needs to directly adjust the output voltage level of the RF-DC power conversion 118 to prevent the voltage regulator circuit 1908 from getting over saturated in voltage or breaking down. The configuration can be use to aid in the tuning of the impedance matching networks in the RF-DC power conversion 118. It can also be used for the purpose of triggering the charging of the floating gate devices in the rectifier circuits to enhance power conversion efficiency or prevent degradation in the performance of the power harvester.

In another embodiment provided without the power management block 1910, and without charge storage device 1906c and having feedback 2100, the antenna 110 collects the RF signal 106 (not shown), the RF-DC 118 rectifies the RF signal 106 to a DC voltage, that is stored on a charge storage device 1906a, the voltage limiter/regulator 1908 regulates the DC voltage from the charge storage device 1906a and its output charges a different charge storage device 1906b. Without the power management circuit, the device 1904 is directly powered by the power from the voltage limiting/regulation circuit 1908 and the charge stored on charge storage 1906b. The feedback 2100 between the device 1904 and the voltage limiting/regulation 1908 allows the device 1904 to control the regulated output voltage level of the power harvester 102. The feed back loop 2100 can be used to partially or fully enabling and disabling the voltage limiter/regulation 1908. It can select between different devices 1904 or reference voltages in the voltage limiter/regulation 1908 to robustly vary the voltage level as seen from the device 1904. This configuration is preferred when the device 1904 does not operate on a wide range power supply and requires the voltage regulation to be very accurate, preferably to within less than 50 mV of the desire operating voltage.

It should be obvious that the above embodiments can be provided without the power without charge storage device 1906c. Charge storage after the power management block 1910 is not necessary when the conduction path between the power harvester output (not shown) and device 1904 is strongly on, and sufficient power can be delivered through this conduction path. The antenna 110 collects the RF signal 104 (not shown), the RF-DC 188 rectifies the RF signal to a DC voltage that is stored on a charge storage device 1906a, the voltage limiter/regulator 1908 regulates the DC voltage from the charge storage device 1906a and its output charges a different charge storage device 1906b. Power management 1910 controls the conduction path between the output of voltage regulator 1908 and the device 1904. Power management 1910 supplies power to the device 1904 when it is needed.

Charge storing 1906b after the voltage limiting/regulation 1908 is not necessary when the power management 1910 is turned on often, thus charging charge 1906b. The antenna 110 collects the RF signal, the RF-DC rectifies the RF signal to a DC voltage that is stored on a charge storage device 1906a, the voltage limiter/regulator 1908 regulates the DC voltage from the charge storage device 1906a and its output is feeding to the power management 1910. Power management 1910 controls the conduction path between the output of voltage regulator 1908 and the device 1904. Power management 1910 supplies power to the device 1904 when it is needed. Charge storage 1906c holds the excess charge from the power harvester 102 when device 1904 is in operation and gives off charge when device 1904 is drawing more current than the power harvester 102 can provide.

It should be obvious that all different possible feedback 2100 configurations for power harvester 102 with feedbacks and without charge storage 1096b after regulator 1908 are possible.

Charge storage 1906a is not needed after the RF-DC power conversion 118 when the power received by the RF-DC power conversion 118 is stable or when the power requirement of the voltage limiting/regulation 1908 does not exceed the power harvested up to RF-DC conversion. The antenna 110 collects the RF signal 104 (not shown), the RF-DC 118 rectifies the RF signal to a DC voltage and is fed directly to the voltage limiter/regulation block 1908, the voltage limiter/regulator 1908 regulates the DC voltage from the output of RF-DC 118 and its output charges a charge storage device 1908b. Power management controls 1910 the conduction path between the output of voltage regulator 1908 and the device 1904. Power management 1910 supplies power to the device 1904 when it is needed. Charge storage 1906c holds the excess charge from the power harvester when device 1904 is in operation and gives off charge when device 1904 is drawing more current than the power harvester circuit 102 can provide.

It should be obvious that all different possible feedback 2100 configurations for power harvester 102 with feedbacks and without charge storage 1096a after regulator 1908 are possible.

In cases where the device 1904 operates at peak power that does not exceed harvested power and/or the regulated power, charge storage device 1906b after the voltage limiter/regulator 1908 and charge storage device 1906c after regulation and power management 1910 are not require as part of the power harvester 102. The antenna 110 collects the RF signal 104 (not shown), the RF-DC 118 rectifies the RF signal to a DC voltage that is stored on a charge storage device 1906a, the voltage regulator 1908 regulates the DC voltage on charge storage 1906a. Power management 1910 controls the conduction path between the output of voltage regulator to device and turn on the conduction switch when power is needed at the device 1904.

It should be obvious that all different possible feedback 2100 configurations for power harvester 102 with feedbacks and without charge storage 1096b after regulator 1908 and 1906c after power management 1910 are possible.

In another embodiment, the charge storage devices 1906a and 1906c are not implemented. The antenna 110 collects the RF signal 104 (not shown), the RF-DC 118 rectifies the RF signal to a DC voltage that is then applied to the voltage limiting/regulation 1908. The voltage limiter/regulator 1908 regulates the DC voltage from the RF-DC power conversion 118 and its output charges charge storage device 1906b. Power management 1910 controls the conduction path between the output of voltage regulator 1908 and the device 1904. Power management 1910 supplies power to the device 1904 when it is needed.

It should be obvious that all different possible feedback 2100 configurations for power harvester 102 with feedbacks and without charge storage 1096a after RF converter 118 and 1906c after power management 1910 are possible.

In another embodiment, the charge storage devices 1906a and 1906b are not implemented. The antenna 110 collects the RF signal 104 (not shown), the RF-DC 118 rectifies the RF signal to a DC voltage that is then applied to the input of the voltage limiter/regulation 1908. The voltage limiter/regulator 1908 regulates the DC voltage from the output of the RF-DC power conversion circuit 118 and its output is fed to the power management 1910. Power management 1910 controls the conduction path between the output of voltage regulator 1908 and the device 1904. Power management 1910 supplies power to the device 1904 when it is needed. Charge storage 1906c holds the excess charge from the power harvester 210 when device 1904 is in operation and gives off charge when device 1904 is drawing more current than the power harvester circuit 102 can provide.

It should be obvious that all different possible feedback 2100 configurations for power harvester 102 with feedbacks and without charge storage 1096a after RF converter 118 and 1906b after voltage limiter/regulator 1908 are possible.

In another embodiment, the charge storage devices 1906a, 1906b and 1906c are not implemented. In cases that device 1904 operates once within a time interval and/or at power level lower than or equal to the harvested power from the RF environment, charge storage devices 1906a 1906b and 1906c are not require as part of the power harvester 102. The antenna 101 collects the RF signal 104 (not shown), the RF-DC rectifies the RF signal to a DC voltage, the voltage regulator regulates the DC voltage from the output of RF-DC. Power management 1910 controls the conduction path between the output of voltage regulator 1908 to device 1904 and turn on the conduction switch when power is needed at the device 1904.

It should be obvious that all different possible feedback 2100 configurations for power harvester 102 with feedbacks and without charge storage 1096a after RF converter 118, 1906b after voltage limiter/regulator 1908, and 1906c after power manager 1910 are possible.

In another embodiment, the charge storage devices 1906b and 1906c are not implemented, and power management 1910 is not implemented. In cases where the device 1904 operates at peak power that does not exceed harvested power and/or the regulated power, power management 19019 and charge storage device 1906c and charge storage device 1906b after voltage regulation 1908 is not require as part of the power harvester 102. The antenna 110 collects the RF signal 104 (not shown), the RF-DC rectifies the RF signal to a DC voltage that is stored on a charge storage device (charge storage 1), the voltage regulator regulates the DC voltage on 1906a. The voltage regulator supplies 1908 the power directly to the device 1904.

It should be obvious that all different possible feedback 2100 configurations for power harvester 102 with feedbacks 2100 and without the charge storage devices 1906b and 1906c, and power management 1910 are possible.

In another embodiment, the charge storage devices 1906a and 1906c are not implemented, and power management 1910 is not implemented. In cases that device 1904 operates once within a time interval and/or at power level lower than or equal to the harvested power from the RF environment, power management 1910 and charge storage 1906c after power management 1910, and charge storage 1906a after RF-DC 118 are not require as part of the power harvester 102. The antenna 110 collects the RF signal 104 (not shown), the RF-DC 118 rectifies the RF signal to a DC voltage, the voltage regulator 1908 regulates the DC voltage from the output of RF-DC 118, that is provided to device 1904.

It should be obvious that all different possible feedback 2100 configurations for power harvester 102 with feedbacks 2100 and without the charge storage devices 1906a and 1906c, and power management 1910 are possible.

In another embodiment, the charge storage devices 1906a, 1906b and 1906c are not implemented, and power management 1910 is not implemented. In cases that device 1904 operates once within a time interval and/or at power level lower than or equal to the harvested power from the RF environment, charge storage devices 1906a, 1906b and 1906c and power management 1910 is not require as part of the power harvester 102. The antenna 110 collects the RF signal 104 (not shown), the RF-DC rectifies the RF signal to a DC voltage, the voltage regulator regulates the DC voltage from the output of RF-DC and provides it to device 1904 and turns on a conduction switch (not shown) when power is needed at the device 1904.

It should be obvious that all different possible feedback 2100 configurations for power harvester 102 with feedbacks 2100 and without the charge storage devices 1906a, 1906b and 1906c, and power management 1910 are possible.

In another embodiment, the charge storage device 1906b and voltage limiter/regulator 1908 are not implemented. In cases that device 1904 operates once within a time interval and/or at power level lower than or equal to the harvested power from the RF environment, charge storage device 1906b is not require as part of the power harvester. The antenna collects the RF signal, the RF-DC rectifies the RF signal to a DC voltage, the voltage is provided to power manager 1910 which can store needed power in storage device 1906c for powering device 1904. The power management 1910 also supplies the power directly to the device 1904.

It should be obvious that all different possible feedback 2100 configurations for power harvester 102 with feedbacks 2100 and without the charge storage devices 1906b after voltage limiter/regulator 1908 and voltage limiter/regulator 1908 are possible.

In another embodiment, the charge storage devices 1906b and 1906c, and voltage limiter/regulator 1908 are not implemented. In cases where the device 1904 is able to tolerate wide power supply ranges, charge storage devices 1906b and 1906c, and voltage limiter/regulator 1908 are not require as part of the power harvester 102. The antenna 110 collects the RF signal 104 (not shown), the RF-DC rectifies the RF signal to a DC voltage that is stored on a charge storage device 1906a. Power management 1910 controls the conduction path between the output of RF-DC 118 to device 1904 and turn on a conduction switch (not shown) when power is needed at the device 1904.

It should be obvious that all different possible feedback 2100 configurations for power harvester 102 with feedbacks 2100 and without the charge storage devices 1906b after voltage limiter/regulator 1908 and charge storage devices 1906b after power manager 1910, and voltage limiter/regulator 1908 are possible.

In another embodiment, the charge storage devices 1906a and 1906b, and voltage limiter/regulator 1908 are not implemented. In cases where the device 1904 is able to tolerate wide power supply ranges, charge storage devices 1906a and 1906b, and voltage regulator 1908 are not require as part of the power harvester 102. The antenna 110 collects the RF signal 104 (not shown), the RF-DC 118 rectifies the RF signal to a DC voltage that is stored on a charge storage device 1906c. Power management 1910 controls the conduction path between the output of RF-DC 118 to device 1908 and turn on a conduction switch (not shown) when power is needed at the device 1904.

It should be obvious that all different possible feedback 2100 configurations for power harvester 102 with feedbacks 2100 and without the charge storage devices 1906a and 1906b, and voltage limiter/regulator 1908 are possible.

In another embodiment, the charge storage devices 1906a, 1906b and 1906c, and voltage limiter/regulator 1908 are not implemented. In cases where the device 1904 is able to tolerate wide power supply ranges, with peak power less than the harvestable energy, the charge storage devices 1906a, 1906b and 1906c, and voltage limiter/regulator 1908 are not require as part of the power harvester 102. The antenna 110 collects the RF signal 104 (not shown), the RF-DC rectifies the RF signal to a DC. In this embodiment, power management 1910 may control the conduction path between the output of the RF-DC 118 to external device 1904. The power management 1910 may responsively “turn on” the conduction when power is needed at the device 1904 or as instructed (for example, by the external device and/or other device).

It should be obvious that all different possible feedback 2100 configurations for power harvester 102 with feedbacks 2100 and without charge storage devices 1906a, 1906b and 1906c, and voltage limiter/regulator 1908 are possible.

In another embodiment, the charge storage devices 1906b and 1906c, and voltage limiter/regulator 1908 and power management 1910 are not implemented. In cases where the device 1904 is able to tolerate wide power supply range, the charge storage devices 1906b and 1906c, and voltage limiter/regulator 1908 and power management 1910 are not require as part of the power harvester 102. The antenna 110 collects the RF signal 104 (not shown), the RF-DC rectifies the RF signal to a DC voltage that is stored on a charge storage device 1906a. The device 1904 is powered by the charge stored on charge storage 1906a.

It should be obvious that all different possible feedback 2100 configurations for power harvester 102 with feedbacks 2100 and without the charge storage devices 1906b and 1906c, and voltage limiter/regulator 1908 and power management 1910 are possible.

In another embodiment, the charge storage devices 1906a, 1906b and 1906c, and voltage limiter/regulator 1908 and power management 1910 are not implemented. This embodiment can be advantageous where the external device 1904 is able to tolerate wide power supply range a, with peak power less than the harvestable energy, the charge storage devices 1906a, 1906b and 1906c, and voltage limiter/regulator 1908 and power management 1910 are not require as part of the power harvester 102. In this embodiment, the antenna 110 collects the RF signal 104 (not shown), the RF-DC rectifies the RF signal to a DC. The device 1904 draws power directly from the output of RF-DC power conversion circuitry 118.

It should be obvious that all different possible feedback 2100 configurations for power harvester 102 with feedbacks 2100 and without the charge storage devices 1906a, 1906b and 1906c, and voltage limiter/regulator 1908 and power management 1910 are possible.

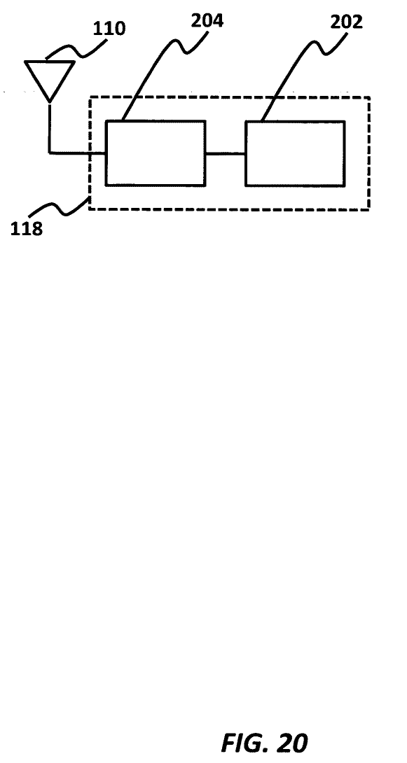

FIG. 22 shows a block diagram of one embodiment of power harvester, according to the current invention, where shown is the antenna 110 connected to the impedance match 204, which is connected to the rectifier 202 of the RF-DC converter 118. In cases where the device 1904 (not shown) is able to tolerate wide power supply range, with peak power less than the harvestable energy, the charge storage devices 1906a, 1906b and 1906c, and voltage limiter/regulator 1908 and power management 1910 not require as part of the power harvester. The RF signal 104 (not shown) is collected at the antenna 110 and passes through impedance matching networks 204 before reaching the rectifier 202. In this embodiment, the impedance matching circuitry 204 may provide an enhanced and/or predetermined impedance match between the output of the antenna 110 and the input of the RF-DC converter 118. For example, the impedance matching circuitry may be high-Q to passively increase the voltage amplitude to the rectifier or it can be low-Q to increase the bandwidth of harvestable RF signal. In certain embodiment, it may be preferred that the impedance be matched to within 5% of the ideal impedance value to achieve higher passive voltage gain from high-Q matching and higher power from low-Q matching.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art.

All such variations are considered to be within the scope and spirit of the present invention as defined by the following claims and their legal equivalents.

What is claimed:

1. A voltage doubler rectifier RF power harvesting system comprising:
a. at least one power harvesting module, wherein said power harvesting module comprises:
i. a voltage doubler rectifier structure circuit, wherein said voltage doubler rectifier structure comprises:
1. a DC voltage input;
2. a DC voltage output;
3. a signal input;
4. a first floating gate transistor and a second floating gate transistor, wherein said floating gate transistors are connected in series between said DC voltage input and said DC voltage output, wherein a gate control of said floating gate is connected to a drain of said transistor;
5. a first capacitor disposed between said input signal and said drain of said first floating gate transistor; and
6. a second capacitor disposed between a ground and said drain of said second floating gate transistor;
b. a harvester antenna, wherein said harvester antenna is disposed to provide a signal to said signal input;
c. a transmitter;
d. a transmitter antenna, wherein said transmitter provides said signal for output from said transmitter antenna, wherein a full-wave peak-to-peak voltage of an incoming RF signal from said transmitter antenna to said signal input is rectified; and
e. a powered device, wherein said powered device is connected to said DC voltage output to utilize said rectified signal.

2. The RF power harvesting system of claim 1, wherein said at least one power harvesting module further comprises at least one charge storage device, wherein said charge storage device is selected from a group consisting of capacitors, rechargeable batteries, and non-rechargeable batteries.

3. The RF power harvesting system of claim 1, wherein said at least one power harvester further comprises a voltage limiting/regulation device, wherein said voltage limiting/regulation device is disposed between said voltage double rectifier structure and said powered device.

4. The RF power harvesting system of claim 3, wherein said at least one power harvesting module further comprises at least one charge storage device, wherein said charge storage device is selected from a group consisting of capacitors, rechargeable batteries, and non-rechargeable batteries.

5. The RF power harvesting system of claim 3, further comprises feedback loops wherein said feedback loops are feedback connections selected from a group consisting of said powered device to said voltage doubler rectifier structure, said powered device to said voltage limiting/regulation device, and said voltage doubler rectifier structure to said voltage limiting/regulation device.

6. The RF power harvesting system of claim 5, wherein said at least one power harvesting module further comprises at least one charge storage device, wherein said charge storage device is selected from a group consisting of capacitors, rechargeable batteries, and non-rechargeable batteries.

7. The RF power harvesting system of claim 1, wherein said at least one power harvesting module further comprises a power management device, wherein said power management device is disposed between said voltage doubler rectifier structure and said powered device.

8. The RF power harvesting system of claim 7, wherein said at least one power harvesting module further comprises at least one charge storage device, wherein said charge storage device is selected from a group consisting of capacitors, rechargeable batteries, and non-rechargeable batteries.

9. The RF power harvesting system of claim 7, wherein said at least one power harvesting module further comprises feedback loops wherein said feedback loops are feedback connections selected from a group consisting of said powered device to said voltage doubler rectifier structure, said powered device to said power management device, and said power management device to said voltage doubler rectifier structure.

10. The RF power harvesting system of claim 7, wherein said at least one power harvesting module further comprises at least one charge storage device, wherein said charge storage device is selected from a group consisting of capacitors, rechargeable batteries, and non-rechargeable batteries.

11. The RF power harvesting system of claim 1, wherein said at least one power harvesting module further comprises a power management device and a voltage limiting/regulation device, wherein said power management device and said voltage limiting/regulation device are disposed between said voltage doubler rectifier structure and said powered device.

12. The RF power harvesting system of claim 11, wherein said at least one power harvesting module further comprises at least one charge storage device, wherein said charge storage device is selected from a group consisting of capacitors, rechargeable batteries, and non-rechargeable batteries.

13. The RF power harvesting system of claim 10 further comprises feedback loops wherein said feedback loops are feedback connections selected from a group consisting of said powered device to said voltage doubler rectifier structure, said powered device to said voltage limiting/regulation device, said powered device to said power management device, said power management device to said voltage limiting/regulation device, said power management device to said voltage doubler rectifier structure, and said voltage/regulation device to said voltage doubler rectifier structure.

14. The RF power harvesting system of claim 11, wherein said at least one power harvesting module further comprises at least one charge storage device, wherein said charge storage device is selected from a group consisting of capacitors, rechargeable batteries, and non-rechargeable batteries.

15. The RF power harvesting system of claim 1, wherein said at least one power harvester further comprises an impedance matching device disposed between said harvester antenna and said voltage doubler rectifier.

16. The RF power harvesting system of claim 15, wherein said impedance matching is an adjustable impedance matching, wherein said adjustment is programmable.

17. The RF power harvesting system of claim 16, wherein said adjustable impedance matching is programmable.

18. The RF power harvesting system of claim 1, wherein said at least one power harvester further comprises passive components disposed between said signal input and said harvesting antenna, whereby a wider band match is provided along a cascade of said power harvesters.

19. The RF power harvesting system of claim 1, wherein said floating gate transistor is selected from a group consisting of a PMOS-PMOScap, a PMOS-NMPScap, an NMOS-NMOScap, an NMOS-PMOScap, an NMOS-MiMcap, and a PMPS-MiMcap.

20. The RF power harvesting system of claim 1, wherein said harvesting antenna is a meanderline antenna, wherein said meanderline antenna comprises an inner loop disposed between a pair of approximately matching outer loops, wherein said inner loop comprises a pair of antenna ports, wherein an input impedance of said meanderline antenna matches an in impedance of said voltage doubler rectifier.

21. The RF power harvesting system of claim 20 wherein said antenna outer loop comprises a perimeter of 35 centimeters.

22. The RF power harvesting system of claim 22 wherein said antenna inner loop comprises a perimeter to match said input impedance of said rectifier.

23. The RF power harvesting system of claim 23 wherein said antenna matching outer loops are disposed to divide said antenna into two identical parts as a virtual ground, wherein a fully differential signal is provided at said antenna ports.

24. The RF power harvesting system of claim 1, wherein said voltage doubler rectifier structure is disposed in at least a two-stage rectifier cascade.

25. The RF power harvesting system of claim 24, wherein said cascade is a 36-stage cascade.

26. The RF power harvesting system of claim 24, wherein said cascade is a 16-stage cascade.
